(19) United States
(12) Patent Application Publication
(10) Pub. No.: US 2023/0176161 A1
(43) Pub. Date: Jun. 8, 2023

(54) RETRIEVING MEASUERMENTS FROM A WIRELESS DEVICE OPERATING IN A WIRELESS DEVICE-BASED POSITIONING MODE

(71) Applicant: Telefonaktiebolaget LM Ericsson (publ), Stockholm (SE)

(72) Inventors: Fredrik GUNNARSSON, Linköping (SE); Ritesh SHREEVASTAV, Upplands Väsby (SE); Åke BUSIN, Sollentuna (SE); Pradeepa RAMACHANDRA, Linköping (SE)

(21) Appl. No.: 17/917,612

(22) PCT Filed: Apr. 2, 2021
(86) PCT No.: PCT/IB2021/052790

§ 371 Date: Oct. 7, 2022

Related U.S. Application Data
(60) Provisional application No. 63/007,508, filed on Apr. 9, 2020.
(60) Provisional application No. 63/012,583, filed on Apr. 20, 2020.

(51) Int. Cl. G01S 5/00; H04W 64/00

(52) U.S. Cl. CPC G01S 5/0036; H04W 64/00

(57) ABSTRACT

A method, system and apparatus are disclosed providing arrangements to retrieve measurements from a wireless device (WD) operating in a WD-based mode. In one embodiment, a method implemented in a network node includes identifying a wireless device, WD, operating in a WD-based positioning mode; and receiving at least one positioning measurement and a positioning estimate from the identified WD; and optionally, using the received at least one positioning measurement to perform at least one positioning action. In one embodiment, a method implemented in a WD includes operating in a WD-based positioning mode; while operating the WD-based positioning mode, receiving a request to report at least one positioning measurement; and reporting the requested at least one positioning measurement and a positioning estimate.

### FIELD

The present disclosure relates to wireless communications, and in particular, to arrangements to retrieve measurements from a wireless device (WD) operating in a WD-based mode.

### BACKGROUND

Positioning has been a topic in the 3^{rd} Generation Partnership Project's (3GPP) Long Term Evolution (LTE) standardization efforts since 3GPP Release 9 (Rel-9). One objective is to fulfill regulatory requirements for emergency call positioning. Referring to FIG. 1, positioning of a wireless device 2 in 3GPP New Radio (NR) (NR is also called 5^{th} Generation or 5G) is proposed to be supported by the architecture shown. A location management function (LMF) 4 may be considered the location node in NR. There are also interactions between the location node and the gNodeB via the NR positioning protocol A (NRPPa) protocol. The interactions between the gNodeB and the wireless device (WD) 2 is supported via the Radio Resource Control (RRC) protocol. The messages between the WD 2 and the LMF 4 are defined by the protocol LTE positioning protocol (LPP), which is signaled via the gNB and the AMF 6. The corresponding location node in LTE is the Evolved Serving Mobile Location Center (E-SMLC) 8, and the LTE base station is denoted eNB, or ng-eNB in case it is deployed in a 3GPP next generation (NG) core network.

Note 1: The gNB and ng-eNB may not always both be present.

Note 2: When both the gNB and ng-eNB are present, the NG-C interface may only be present for one of them.

In legacy/existing LTE standards, the following techniques may be supported:
Enhanced Cell identifier (ID): Essentially cell ID information to associate the wireless device 2 to the serving area of a serving cell, and then additional information to determine a finer granularity position.
Assisted Global navigation satellite system (GNSS): GNSS information retrieved by the wireless device 2, supported by assistance information provided to the wireless device 2 from the E-SMLC 8.
OTDOA (Observed Time Difference of Arrival): The wireless device 2 estimates the time difference of reference signals from different base stations and sends to the E-SMLC 8 for multilateration.
UTDOA (Uplink TDOA): The wireless device 2 is requested to transmit a specific waveform that is detected by multiple location measurement units (e.g., an eNB) at known positions. These measurements are forwarded to the E-SMLC 8 for multilateration.
Sensor methods such as Biometric pressure sensor which provides vertical position of the wireless device 2 and Inertial Motion Unit (IMU) which provides displacement.

The positioning modes may be categorized in one or more of the below three areas:
WD-Assisted: The WD 2 performs measurements with or without assistance from the network and sends these measurements to the E-SMLC 8 where the position estimate calculation may take place.
WD-Based: The WD 2 performs measurements and calculates its own position estimate with assistance from the network.
Standalone: The WD 2 performs measurements and calculates its own position estimate without network assistance.

A new work item (WI) on “NR Positioning Support” was considered during 3GPP RAN #83. The objectives include: Study and, if agreed, specify system level aspects of the downlink (DL)-only WD based positioning [RAN2]. As part of this WI, DL-TDOA and DL-AoD (Angle of Departure) has been defined as a WD-based positioning method.

In the DL AoD positioning method, the WD 2 position may be estimated based on DL positioning reference signal (PRS) reference signal received power (RSRP) measurements taken at the WD 2 of downlink radio signals from multiple NR transmission/reception points (TRPs), along with knowledge of the geographical coordinates of the TRPs and their relative downlink timing.

The DL TDOA positioning method makes use of the DL PRS reference signal time difference (RSTD) (and optionally DL PRS RSRP) of downlink signals received from multiple transmission points (TPs), at the WD 2. The WD 2 measures the DL PRS RSTD (and optionally DL PRS RSRP) of the received signals using assistance data received from the positioning server, and the resulting measurements are used along with other configuration information to locate the WD 2 in relation to the neighboring TPs.

MDT

Minimization of drive test (MDT) is used as an alternative to the drive tests for obtaining certain types of WD measurements results for SON related features such as network planning, network optimization, network parameter tunning or setting (e.g., base station transmit power, number of receive and/or transmit antennas etc.), or even for positioning (e.g., RF pattern matching based positioning). The WD is configured by the network for logging the measurements. Two MDT modes exist immediate MDT and logged MDT:

Immediate MDT comprising measurement performed by WD in the high RRC activity states (e.g., RRC CONNECTED state in LTE and NR etc) and the reporting of the measurements to a network node (e.g., eNodeB, gNode B, etc.) when reporting condition is met e.g., event is triggered.

Logged MDT functionality comprising measurement performed by WD when operating in a low RRC activity state (e.g., RRC idle, RRC inactive etc). The network uses Logged Measurement Configuration message to configure the WD to perform logging of measurement results in low RRC activity state which can be stored in the WD for up to 48 hours before reporting. The configuration comprises information such as absolute time in the cell, logging duration, logging interval or periodicity (e.g., how often the measurements are logged), information about area where logging is required etc. The logging duration can vary from few minutes to several hours. The WD transmits the measurement results along with relative time stamp for each log, which indicates the time of logging measurement results relative to the absolute time received (received from the network), location information of the logged results (optional), etc.

### SUMMARY

Some embodiments advantageously provide methods, systems, and apparatuses for arrangements to retrieve measurements from a wireless device (WD) operating in a WD-based mode.

Some embodiments advantageously provide methods, systems, and apparatuses for configuration and reporting of measurement results and location calculations for wireless device (WD) based positioning.

In one embodiment, a method implemented in a network node includes sending a location information request to the wireless device, the location information request requesting measurements and a positioning estimate from the wireless device; as a result of the location information request, receiving the measurements and the positioning estimate from the wireless device; and using the received measurements and the positioning estimate to perform at least one positioning action.

In one embodiment, a method implemented in a WD includes receiving a location information request from the network node, the location information request requesting measurements and a positioning estimate from the wireless device; as a result of the location information request, determining the measurements and the positioning estimate; and sending the measurements and the positioning estimate to the network node.

In one embodiment, a network node is configured to obtain an indication of at least one WD capability, the at least one WD capability comprising a WD-based positioning capability and a minimization of drive test (MDT) capability; and notify at least one other network node about the indicated at least one WD capability.

In one embodiment, a WD is configured to indicate at least one WD capability, the at least one WD capability comprising a WD-based positioning capability and a minimization of drive test (MDT) capability; receive a configuration of a positioning report based at least in part on the at least one WD capability; and send the configured positioning report including the WD's location information.

In one embodiment, a network node is configured to obtain an indication of at least one WD capability, the at least one WD capability comprising a WD-based positioning capability and a minimization of drive test (MDT) capability; and configure the WD with a positioning report based at least in part on the at least one WD capability.

According to an aspect of the present disclosure, a method implemented in a network node is provided. The method comprises identifying a wireless device, WD, operating in a WD-based positioning mode; and receiving at least one positioning measurement and a positioning estimate from the identified WD; and optionally, using the received at least one positioning measurement to perform at least one positioning action.

In some embodiments of this aspect, the method further includes sending a location information request to the WD, the location information request requesting the at least one positioning measurement from the WD operating in the WD-based positioning mode. In some embodiments of this aspect, the network node comprises a location management function, LMF. In some embodiments of this aspect, the location information request includes a location information type, the location information type instructing the WD operating in the WD-based positioning mode to report the requested at least one positioning measurement and the positioning estimate. In some embodiments of this aspect, the location information type instructs the WD operating in the WD-based positioning mode to report both the at least one measurement and the positioning estimate.

In some embodiments of this aspect, the method further includes receiving the at least one measurement and the positioning estimate from the WD as a result of the location information request. In some embodiments of this aspect, the method further includes configuring the identified WD to perform a minimization of drive test, MDT, logging. In some embodiments of this aspect, the network node is an operations and maintenance, OAM, network node. In some embodiments of this aspect, configuring the WD to perform MDT logging further comprises configuring the WD to include at least one positioning measurement from the MDT logging in a positioning report. In some embodiments of this aspect, the method further includes receiving the positioning report comprising the at least one positioning measurement from the WD operating in the WD-based positioning mode.

According to another aspect of the present disclosure, a method implemented in a wireless device, WD, is provided. The method comprises operating in a WD-based positioning mode; while operating the WD-based positioning mode, receiving a request to report at least one positioning measurement; and reporting the requested at least one positioning measurement and a positioning estimate.

In some embodiments of this aspect, receiving the request comprises receiving a location information request to the WD, the location information request requesting the at least one positioning measurement and the positioning estimate from the WD operating in the WD-based positioning mode. In some embodiments of this aspect, receiving the request to report the at least one positioning measurement from a location management function, LMF, network node. In some embodiments of this aspect, the location information request includes a location information type, the location information type instructing the WD operating in the WD-based positioning mode to report the requested at least one positioning measurement. In some embodiments of this aspect, the location information type instructs the WD operating in the WD-based positioning mode to report both the at least one positioning measurement and the positioning estimate.

In some embodiments of this aspect, the method further includes performing the at least one positioning measurement; and calculating the positioning estimate for the WD based at least in part on the at least one positioning measurement. In some embodiments of this aspect, the method further includes receiving a configuration to perform a minimization of drive test, MDT, logging. In some embodiments of this aspect, receiving the configuration to perform the MDT logging from an operations and maintenance, OAM, network node. In some embodiments of this aspect, the configuration instructs the WD to include at least one positioning measurement from the MDT logging in a positioning report. In some embodiments of this aspect, reporting further comprises sending the positioning report comprising the at least one positioning measurement from the MDT logging.

According to yet another aspect of the present disclosure, a network node comprising processing circuitry is provided. The processing circuitry is configured to cause the network node to identify a wireless device, WD, operating in a WD-based positioning mode; receive at least one positioning measurement and a positioning estimate from the identified WD; and optionally, using the received at least one positioning measurement to perform at least one positioning action.

In some embodiments of this aspect, the processing circuitry is further configured to cause the network node to send a location information request to the WD, the location information request requesting the at least one positioning measurement from the WD operating in the WD-based positioning mode. In some embodiments of this aspect, the network node comprises a location management function, LMF. In some embodiments of this aspect, the location information request includes a location information type, the location information type instructing the WD operating in the WD-based positioning mode to report the requested at least one positioning measurement.

In some embodiments of this aspect, the location information type instructs the WD operating in the WD-based positioning mode to report both the at least one positioning measurement and the positioning estimate. In some embodiments of this aspect, the processing circuitry is further configured to cause the network node to receive the at least one measurement and the positioning estimate from the WD as a result of the location information request. In some embodiments of this aspect, the processing circuitry is further configured to cause the network node to configure the identified WD to perform a minimization of drive test, MDT, logging.

In some embodiments of this aspect, the network node is an operations and maintenance, OAM, network node. In some embodiments of this aspect, the processing circuitry is configured to cause the network node to configure the WD to perform MDT logging by being configured to cause the network node to configure the WD to include at least one positioning measurement from the MDT logging in a positioning report. In some embodiments of this aspect, the processing circuitry is further configured to cause the network node to receive the positioning report comprising the at least one positioning measurement from the WD operating in the WD-based positioning mode.

According to another aspect of the present disclosure, a wireless device, WD, comprising processing circuitry is provided. The processing circuitry is configured to cause the WD to operate in a WD-based positioning mode; while operating the WD-based positioning mode, receive a request to report at least one positioning measurement; and report the requested at least one positioning measurement and a positioning estimate.

In some embodiments of this aspect, the processing circuitry is configured to cause the WD to receive the request by being configured to cause the WD to receive a location information request to the WD, the location information request requesting the at least one positioning measurement and the positioning estimate from the WD operating in the WD-based positioning mode. In some embodiments of this aspect, the processing circuitry is configured to cause the network node to receive the request to report the at least one positioning measurement from a location management function, LMF, network node. In some embodiments of this aspect, the location information request includes a location information type, the location information type instructing the WD operating in the WD-based positioning mode to report the requested at least one positioning measurement.

In some embodiments of this aspect, the location information type instructs the WD operating in the WD-based positioning mode to report both the at least one positioning measurement and the positioning estimate. In some embodiments of this aspect, the processing circuitry is further configured to cause the WD to perform the at least one positioning measurement; and calculate the positioning estimate for the WD based at least in part on the at least one positioning measurement. In some embodiments of this aspect, the processing circuitry is further configured to cause the WD to receive a configuration to perform a minimization of drive test, MDT, logging. In some embodiments of this aspect, the processing circuitry is configured to cause the WD to receive the configuration to perform the MDT logging from an operations and maintenance, OAM, network node.

In some embodiments of this aspect, the configuration instructs the WD to include at least one positioning measurement from the MDT logging in a positioning report. In some embodiments of this aspect, the processing circuitry is configured to cause the WD to report by being configured to cause the WD to send the positioning report comprising the at least one positioning measurement from the MDT logging.

According to yet another aspect of the present disclosure, an apparatus comprising processing circuitry configured to execute computer instructions to perform any one or more of methods above is provided.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates an example of NG-RAN Release 15 (Rel-15) LCS protocols;

FIG. 2 is a schematic diagram of an exemplary network architecture illustrating a communication system connected via an intermediate network to a host computer according to the principles in the present disclosure;

FIG. 3 is a block diagram of a host computer communicating via a network node with a wireless device over an at least partially wireless connection according to some embodiments of the present disclosure;

FIG. 4 is a flowchart illustrating exemplary methods implemented in a communication system including a host computer, a network node and a wireless device for executing a client application at a wireless device according to some embodiments of the present disclosure;

FIG. 5 is a flowchart illustrating exemplary methods implemented in a communication system including a host computer, a network node and a wireless device for receiving user data at a wireless device according to some embodiments of the present disclosure;

FIG. 6 is a flowchart illustrating exemplary methods implemented in a communication system including a host computer, a network node and a wireless device for receiving user data from the wireless device at a host computer according to some embodiments of the present disclosure;

FIG. 7 is a flowchart illustrating exemplary methods implemented in a communication system including a host computer, a network node and a wireless device for receiving user data at a host computer according to some embodiments of the present disclosure;

FIG. 8 is a flowchart of an exemplary process in a network node for requestor according to some embodiments of the present disclosure;

FIG. 9 is a flowchart of an exemplary process in a wireless device for provider according to some embodiments of the present disclosure;

FIG. 10 is a flowchart of an exemplary process in a network node (e.g., location node, LMF) according to some embodiments of the present disclosure;

FIG. 11 is a flowchart of an exemplary process in a network node (e.g., OAM, ORAN) according to some embodiments of the present disclosure;

FIG. 12 is a flowchart of an exemplary process in a wireless device according to some embodiments of the present disclosure;

FIG. 13 is a flowchart of another exemplary process in a network node according to some embodiments of the present disclosure;

FIG. 14 is a flowchart of another exemplary process in a wireless device according to some embodiments of the present disclosure;

FIG. 15 illustrates an embodiment of the present disclosure from a network node perspective;

FIG. 16 illustrates an embodiment of the present disclosure from a WD perspective;

FIG. 17 is a call flow diagram illustrating an example of signaling mechanisms between a network node and wireless device according to some embodiments of the present disclosure;

FIG. 18 illustrates an embodiment of the present disclosure from a WD perspective;

FIG. 19 illustrates an embodiment of the present disclosure from a network node perspective;

FIG. 20 illustrates an example of an interaction between WD, LMF and OAM for configuration for WD-based RAT dependent positioning method;

FIG. 21 illustrates an example signaling diagram according to some embodiments of the present disclosure;

FIG. 22 illustrates an example signaling diagram according to some embodiments of the present disclosure;

FIG. 23 illustrates an example signaling diagram according to some embodiments of the present disclosure;

FIG. 24 illustrates an example signaling diagram according to some embodiments of the present disclosure; and

FIG. 25 illustrates an example call flow diagram according to one embodiment of the present disclosure.

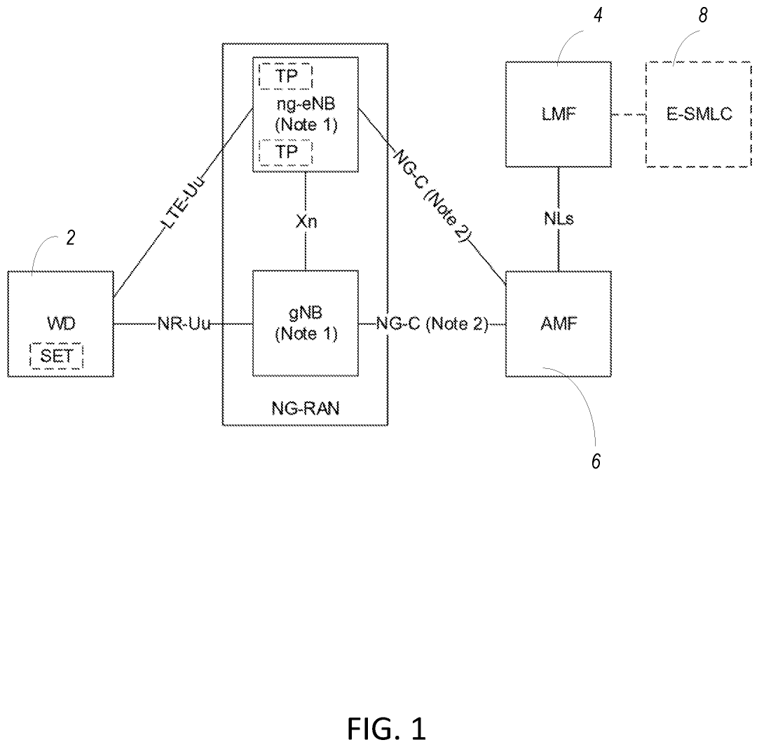

### DETAILED DESCRIPTION

For most of the emerging positioning applications, it is expected that the positioning client will be in the WD (location services (LCS) client), and further that the WD will be capable of performing WD-based positioning methods. In such cases, the measurement logs may not be provided to the network (e.g., network node), which otherwise (in network (NW)-assisted cases) would have been obtained. The network, e.g., network node, may use the log to determine the PRS utilization and to understand the coverage and measurement quality/uncertainty.

In addition, currently, there is a provision in LTE positioning protocol (LPP) (3GPP Technical Specification 37.355) to provide periodical reports. However, this requires the WD to be in connected mode (e.g., Radio Resource Control (RRC) connected mode). For WD-based positioning methods, the positioning client is expected to be in the WD (the WD to be the consumer of positioning). In such case, the measurement logs may not be provided to the network (NW); which otherwise (in NW assisted case) would have been obtained periodically. The NW uses the log to determine the positioning reference signal (PRS) utilization and to understand the coverage and measurement quality/uncertainty.

Example information that may be transferred from the WD to the LMF are shown in the table below, Table 1.

| Information | WD-assisted | WD-based |
|---|---|---|
| Latitude/Longitude/Altitude, together with | No | Yes |
| uncertainty shape | | |
| PCI, GCI, and TRP ID for each measurement | Yes | Yes |
| DL RSTD measurement | Yes | No |
| DL PRS RSRP measurement | Yes | No |
| Time stamp of the measurement | Yes | No |
| Quality for each measurement | Yes | No |

As seen above in Table 1 for WD-based information, the network will not have much information from WD especially regarding the RSTD, RSRP and Quality statistics.

In some embodiments of the present disclosure, a signaling mechanism is provided between the location server and WD, which may enable the retrieval of measurements and positioning estimates from the WD. Some embodiments may advantageously provide for the retrieved measurement which may be useful from the NW and also in some cases for the WD in one or more of the below contexts:
For Integrity purposes: the WD provides the results so that the NW (e.g., network node) can cross-verify that the calculated position is correct.
To allow use of co-operative WDs, providing measurement results enabling the NW to analyze characteristics of the positioning deployment.
The network node may adapt the assistance data (broadcast and unicast) based upon the WD measurements.
With positioning quality and measurement statistics information in the network node, the network node can determine the benefit of different measurements and/or which entities are providing relevant information with respect to observed positioning estimate quality.

Further, the mechanisms provided by some embodiments may enhance information in the network node with positioning estimates and measurements, which may be used to position other devices only providing measurements. Such mechanisms are sometimes referred to a radio frequency fingerprinting.

MDT is a framework to obtain the WD location and other measurement statistics from the WD.

It is the Operations, Administration and Maintenance (OAM) entity that configures the MDT; whereas it is primarily the LMF and for uplink (UL) Positioning methods requiring UL sounding reference signal (SRS) transmission from the WD, then gNB that provides the necessary assistance data (auxiliary) for the WD to be able to compute its location.

The OAM entity may not be aware of which WD is currently (potentially) using a WD-based mechanism. Thus, it may not be possible to retrieve the logs from the WD-based WD.

Some embodiments of the present disclosure provide methods and embodiments whereby the WD operating in WD-based mode is identified and MDT reporting/logging is configured to such WD.

In some embodiments, an interface between the OAM and the LMF is defined.

In one embodiment, the WD may perform one or more of the following steps:
provide the network node with the capability of positioning measurements and whether the WD supports WD-based positioning; and
receive a configuration and positioning measurement reporting mechanisms from the network.

In one embodiment, one or more network nodes may perform one or more of the following steps:
obtain the capability from the WD as to if the WD is capable of performing the WD-based positioning measurements and also the WD capabilities associated to the MDT;
exchange the WD-based positioning and MDT capabilities information among nodes such as the LMF, RAN and OAM;
configure a measurement report for RRC Inactive and Idle mode via the OAM interface for such capable WD; and
obtain user location and other measurement statistics from the WD that operates in the WD-based mode.
   Some embodiments of the present disclosure may provide one or more advantages, such as:
for the NW to have the possibility to obtain results performed by the WD in RRC Idle or RRC Inactive state for WDs which are operating in WD-based mode.
provide more hits to obtain WD location and relevant measurement statistics/events (Handover, Radio Link Failure (RLF), Positioning measurements (RSTD, PRS RSRP)).
with quality measurement statistics information in the LMF, the LMF can determine the PRS utilization, which beams/cells are used for location calculation and what is the quality associated; is there any interference, is there a usefulness for power boosting or a usefulness to use different PRS/SRS transmission patterns, or selecting different SRS transmission comb patterns, etc.

Some arrangements disclosed herein may provide a database for fingerprint-based positioning techniques.

Before describing in detail exemplary embodiments, it is noted that the embodiments reside primarily in combinations of apparatus components and processing steps related to arrangements to retrieve measurements from a wireless device (WD) operating in a WD-based mode and related to configuration and reporting of measurement results and location calculations for wireless device (WD) based positioning. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), OAM, MME/AMF, LMF, etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

The term “signaling” used herein may comprise any of: high-layer signaling (e.g., via Radio Resource Control (RRC) or a like), lower-layer signaling (e.g., via a physical control channel or a broadcast channel), or a combination thereof. The signaling may be implicit or explicit. The signaling may further be unicast, multicast or broadcast. The signaling may also be directly to another node or via a third node.

The term “radio measurement” used herein may refer to any measurement performed on radio signals. Radio measurements can be absolute or relative. Radio measurement may be called as signal level which may be signal quality and/or signal strength. Radio measurements can be e.g., intra-frequency, inter-frequency, inter-RAT measurements, CA measurements, etc. Radio measurements can be unidirectional (e.g., DL or UL) or bidirectional (e.g., Round Trip Time (RTT), Receive-Transmit (Rx-Tx), etc.). Some examples of radio measurements: timing measurements (e.g., Time of Arrival (TOA), timing advance, RTT, Reference Signal Time Difference (RSTD), Rx-Tx, propagation delay, etc.), angle measurements (e.g., angle of arrival), power-based measurements (e.g., received signal power, Reference Signals Received Power (RSRP), received signal quality, Reference Signals Received Quality (RSRQ), Signal-to-interference-plus-noise Ratio (SINR), Signal Noise Ratio (SNR), interference power, total interference plus noise, Received Signal Strength Indicator (RSSI), noise power, etc.), cell detection or cell identification, radio link monitoring (RLM), system information (SI) reading, etc. The inter-frequency and inter-RAT measurements are carried out by the WD in measurement gaps unless the WD is capable of doing such measurement without gaps. Examples of measurement gaps are measurement gap id #0 (each gap of 6 ms occurring every 40 ms), measurement gap id #1 (each gap of 6 ms occurring every 80 ms), etc. The measurement gaps are configured at the WD by the network node.

An indication (generally may explicitly and/or implicitly indicate the information it represents and/or indicates. Implicit indication may for example be based on position and/or resource used for transmission. Explicit indication may for example be based on a parametrization with one or more parameters, and/or one or more index or indices corresponding to a table, and/or one or more bit patterns representing the information.

Configuring a Radio Node

Configuring a radio node, in particular a terminal or user equipment or the WD, may refer to the radio node being adapted or caused or set and/or instructed to operate according to the configuration (e.g., to provide MDT logs/measurements/reports, operate in a WD-based positioning mode). Configuring may be done by another device, e.g., a network node (for example, a radio node of the network like a base station or eNodeB) or network, in which case it may comprise transmitting configuration data to the radio node to be configured. Such configuration data may represent the configuration to be configured and/or comprise one or more instruction pertaining to a configuration, e.g., a configuration for transmitting and/or receiving on allocated resources, in particular frequency resources, or e.g., configuration for performing certain measurements on certain subframes or radio resources. A radio node may configure itself, e.g., based on configuration data received from a network or network node. A network node may use, and/or be adapted to use, its circuitry/ies for configuring. Allocation information may be considered a form of configuration data. Configuration data may comprise and/or be represented by configuration information, and/or one or more corresponding indications and/or message/s.

Configuring in General

Generally, configuring may include determining configuration data representing the configuration and providing, e.g., transmitting, it to one or more other nodes (parallel and/or sequentially), which may transmit it further to the radio node (or another node, which may be repeated until it reaches the wireless device). Alternatively, or additionally, configuring a radio node, e.g., by a network node or other device, may include receiving configuration data and/or data pertaining to configuration data, e.g., from another node like a network node, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal (e.g., WD) may comprise scheduling downlink and/or uplink transmissions for the terminal, e.g., downlink data and/or downlink control signaling and/or DCI and/or uplink control or data or communication signaling, in particular acknowledgement signaling, and/or configuring resources and/or a resource pool therefor. In particular, configuring a terminal (e.g., WD) may comprise configuring the WD to perform certain measurements on certain subframes or radio resources and reporting such measurements and/or positioning estimates calculated by the WD according to some embodiments of the present disclosure.

In some embodiments, the term “obtain” or “obtaining” is used herein and may indicate obtaining in e.g., memory such as in the case where the information is predefined. The term “obtain” or “obtaining” as used herein may also indicate obtaining by receiving signaling indicating the information obtained.

In some embodiments, the term OAM may be used to refer to an operations and maintenance unit. This could be a traditional OAM entity, or this could be an Open RAN (ORAN) based network node that desires to collect performance measurements.

As used herein, the term radio access network (RAN) node may be used to refer to the network node that houses the RRC entity (the one that configures the WD-based positioning and the MDT configuration to the WD) in split or non-split architectures of the radio access network.

In some embodiments, the term MME/AMF is used to refer to the core network node that manages the mobility of the WD in the core network and may be referred to more generally as a mobility management node.

In some embodiments, the term LMF is used to refer to the core network node that manages the Location of the WD in the core network and may be referred to more generally as a location node.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide arrangements to retrieve measurements from a wireless device (WD) operating in a WD-based mode.

Some embodiments provide for configuration and reporting of measurement results and location calculations for wireless device (WD) based positioning.

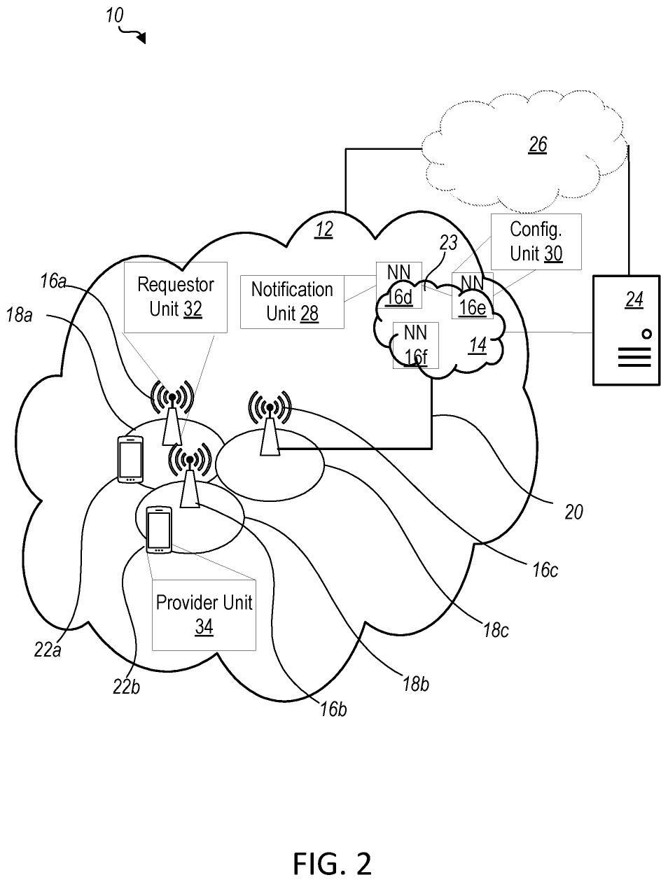

Referring now to the drawing figures, in which like elements are referred to by like reference numerals, there is shown in FIG. 2 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c, 16d, 16e (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

In some embodiments, one or more network nodes (NNs/NWs), such as network nodes 16d, 16e, 16f may be included in the core network 14. The network node 16d (e.g., location node, LMF node), network node 16e (OAM node), network node 16f (e.g., mobility management node, MME/AMF) may be configured to support the positioning arrangements disclosed here. In some embodiments, there may be an interface 23, which may include wired and/or wireless connections, between network node 16d and network node 16e, and which may be configured to support one or more of the positioning arrangements disclosed herein.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections between the communication system 10 and the host computer 24 may extend directly from the core network 14 to the host computer 24 or may extend via an optional intermediate network 26. The intermediate network 26 may be one of, or a combination of more than one of, a public, private or hosted network. The intermediate network 26, if any, may be a backbone network or the Internet. In some embodiments, the intermediate network 26 may comprise two or more sub-networks (not shown).

The communication system of FIG. 2 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 26 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a notification unit 28 which is configured to obtain an indication of at least one WD capability, the at least one WD capability comprising a WD-based positioning capability and a minimization of drive test (MDT) capability; and notify at least one other network node about the indicated at least one WD capability.

A network node 16 is configured to include a configuration unit 36 which is configured to obtain an indication of at least one WD capability, the at least one WD capability comprising a WD-based positioning capability and a minimization of drive test (MDT) capability; and configure the WD with a positioning report based at least in part on the at least one WD capability.

A network node 16 is configured to include a requestor unit 32 which is configured to send a location information request to the wireless device, the location information request requesting measurements and a positioning estimate from the wireless device; as a result of the location information request, receive the measurements and the positioning estimate from the wireless device; and use the received measurements and the positioning estimate to perform at least one positioning action.

A wireless device 22 is configured to include a provider unit 34 which is configured to receive a location information request from the network node, the location information request requesting measurements and a positioning estimate from the wireless device; as a result of the location information request, determine the measurements and the positioning estimate; and send the measurements and the positioning estimate to the network node. In some embodiments, the wireless device 22 is configured to include a positioning unit which is configured to indicate at least one WD capability, the at least one WD capability comprising a WD-based positioning capability and a minimization of drive test (MDT) capability; receive a configuration of a positioning report based at least in part on the at least one WD capability; and send the configured positioning report including the WD's location information.

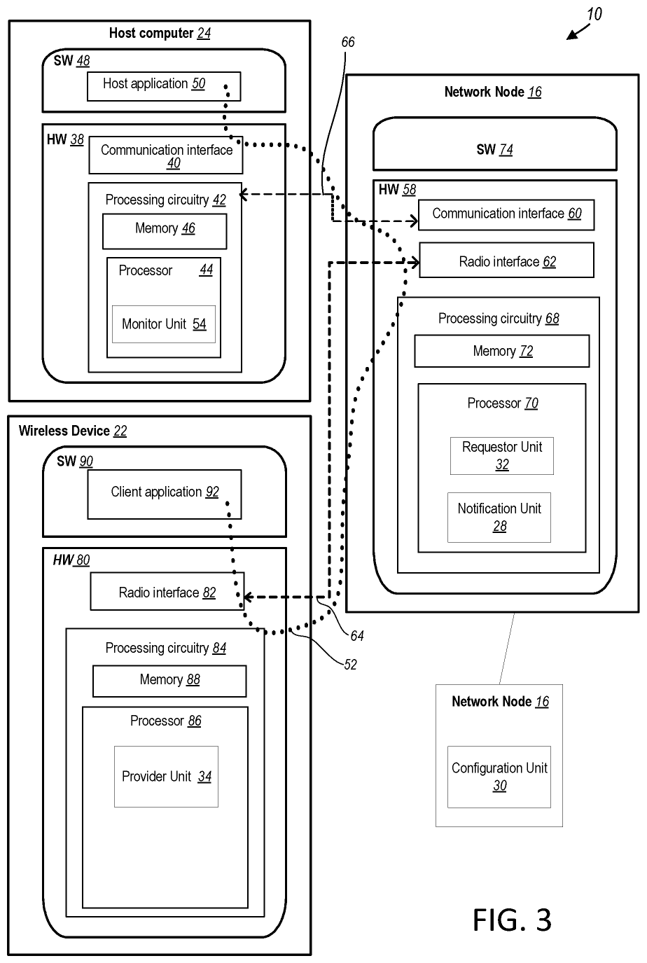

Example implementations, in accordance with an embodiment, of the WD 22, network node 16 and host computer 24 discussed in the preceding paragraphs will now be described with reference to FIG. 3. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22. The processing circuitry 42 of the host computer 24 may include a monitor unit 54 configured to enable the service provider to observe, monitor, control, transmit to and/or receive from the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 26 outside the communication system 10.

In some embodiments, the communication interface 60 and/or the radio interface 62 may be configured to communicate with a wireless device 22 such as exchanging 3GPP LPP messages.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

The processor 70 may be configured to determine the contents of the LPP messages, and to process the information provided by one or more wireless devices 22. In one embodiment, the processor 70 is configured to analyze the measurement and the positioning estimate for validity. In another embodiment, the processor 70 correlates the position estimate and optionally also the quality with the measurements optionally with quality, for example to determine favorable signal configurations for better position estimate, non-favorable signal configurations for less accurate position estimates etc. In another embodiment, the processor 70 is configured to process position estimate and measurement data to enhance stored information used for positioning.

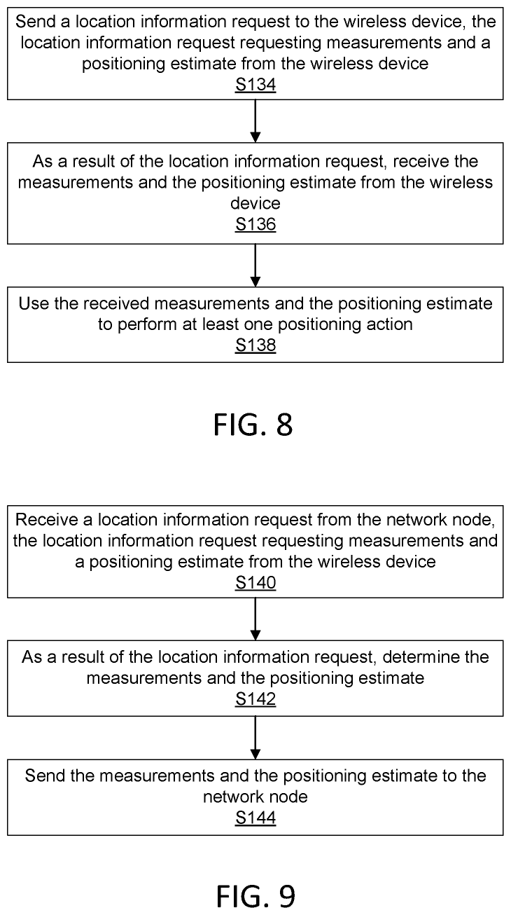

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. The memory 72 may be configured for storing information and data associated to the processing in the network node 16. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include requestor unit 32 configured to perform network node methods discussed herein, such as the methods discussed with reference to FIG. 8 as well as other figures. In some embodiments, the processing circuitry 68 of the network node 16 may include notification unit 28 and/or configuration unit 30 configured to perform network node methods discussed herein.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers. The radio interface 82 may be configured to communicate with a network node 16 such as exchanging 3GPP LPP messages.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

The processor 86 is configured to determine the contents of the LPP messages, and to process the measurements to estimate a position, optionally based on assistance data obtained via communication interface/circuitry and/or the radio interface 82.

The memory 88 is configured to store information associated to the processing, the communication interface/circuitry and/or the radio interface 82. The radio interface 82 is configured to obtain radio measurements to support positioning, optionally supported by assistance data.

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a provider unit 34 configured to perform WD methods discussed herein, such as the methods discussed with reference to FIG. 9 as well as other figures.

In some embodiments, the inner workings of the network node 16, WD 22, and host computer 24 may be as shown in FIG. 3 and independently, the surrounding network topology may be that of FIG. 2.

In FIG. 3, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 2 and 3 show various “units” such as notification unit 28, configuration unit 30, requestor unit 32, and provider unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

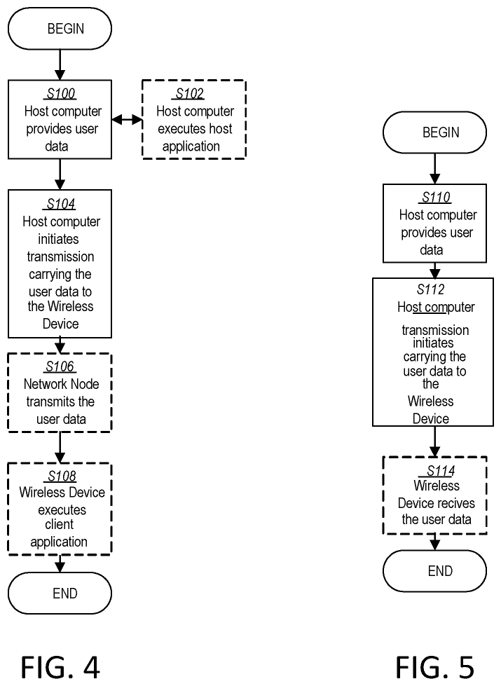

FIG. 4 is a flowchart illustrating an exemplary method implemented in a communication system, such as, for example, the communication system of FIGS. 2 and 3, in accordance with one embodiment. The communication system may include a host computer 24, a network node 16 and a WD 22, which may be those described with reference to FIG. 3. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 5 is a flowchart illustrating an exemplary method implemented in a communication system, such as, for example, the communication system of FIG. 2, in accordance with one embodiment. The communication system may include a host computer 24, a network node 16 and a WD 22, which may be those described with reference to FIGS. 2 and 3. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

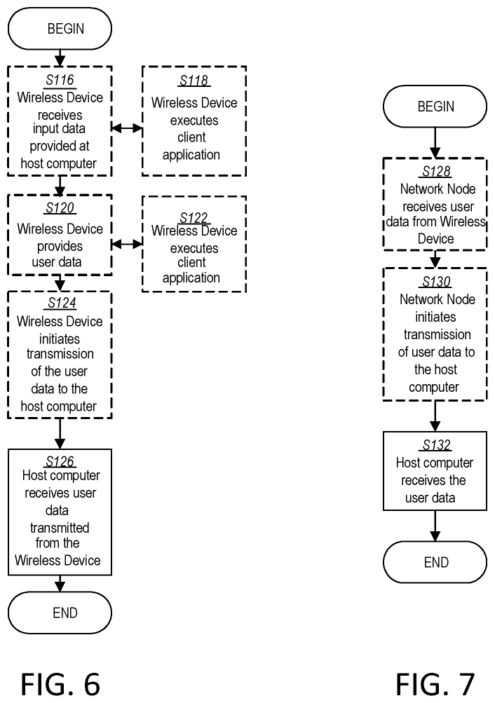

FIG. 6 is a flowchart illustrating an exemplary method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 7 is a flowchart illustrating an exemplary method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

FIG. 8 is a flowchart of an exemplary process in a network node 16 according to some embodiments of the present disclosure. One or more Blocks and/or functions and/or methods performed by the network node 16 may be performed by one or more elements of network node 16 such as by requestor unit 32 in processing circuitry 68, processor 70, radio interface 62, etc. according to the example method. The example method includes sending (Block S134), such as via requestor unit 32, processing circuitry 68, processor 70, communication interface 60 and/or radio interface 62, a location information request to the wireless device, the location information request requesting measurements and a positioning estimate from the wireless device. The method includes, as a result of the location information request, receiving (Block S136), such as via requestor unit 32, processing circuitry 68, processor 70, communication interface 60 and/or radio interface 62, the measurements and the positioning estimate from the wireless device. The method includes using (Block S138), such as via requestor unit 32, processing circuitry 68, processor 70, communication interface 60 and/or radio interface 62, the received measurements and the positioning estimate to perform at least one positioning action.

In some embodiments, the location information request includes a location information type, the location information type indicating to the wireless device to report both the measurement and the positioning estimate, or an error if the wireless device is unable to report the measurement and the positioning estimate. In some embodiments, the location information request one or more of: is included in a Long Term Evolution (LTE) positioning protocol (LPP) message; and indicates a type of measurement per positioning method.

FIG. 9 is a flowchart of an exemplary process in a wireless device 22 according to some embodiments of the present disclosure. One or more Blocks and/or functions and/or methods performed by WD 22 may be performed by one or more elements of WD 22 such as by provider unit 34 in processing circuitry 84, processor 86, radio interface 82, etc. The example method includes receiving (Block S140), such as via provider unit 34, processing circuitry 84, processor 86 and/or radio interface 82, a location information request from the network node, the location information request requesting measurements and a positioning estimate from the wireless device. The method includes, as a result of the location information request, determining (Block S142), such as via provider unit 34, processing circuitry 84, processor 86 and/or radio interface 82, the measurements and the positioning estimate. The method includes sending (Block S144), such as via provider unit 34, processing circuitry 84, processor 86 and/or radio interface 82, the measurements and the positioning estimate to the network node.

In some embodiments, the location information request includes a location information type, the location information type indicating to the wireless device to report both the measurement and the positioning estimate, or an error if the wireless device is unable to report the measurement and the positioning estimate. In some embodiments, the location information request one or more of: is included in a Long Term Evolution (LTE) positioning protocol (LPP) message; and indicates a type of measurement per positioning method.

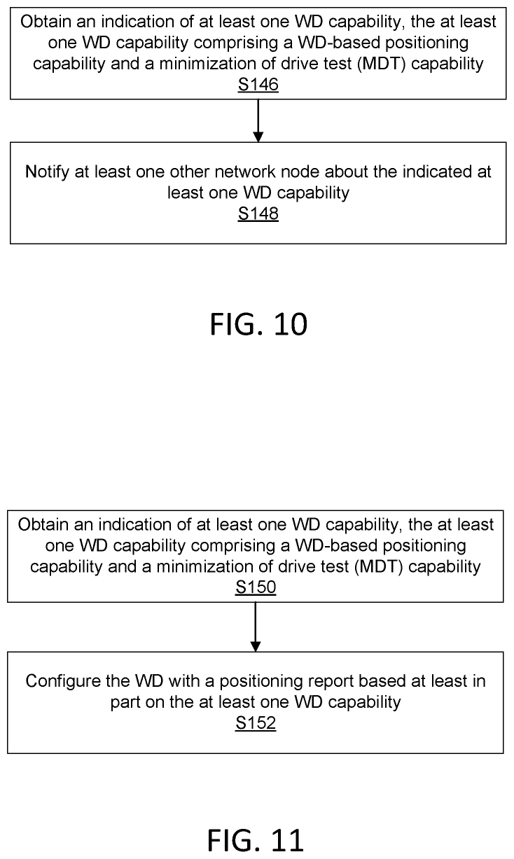

FIG. 10 is a flowchart of an example process in a network node 16 (e.g., location/positioning node, LMF) according to some embodiments of the present disclosure. One or more Blocks and/or functions and/or methods performed by the network node 16 may be performed by one or more elements of network node 16 such as by notification unit 28 in processing circuitry 68, processor 70, radio interface 62, etc. according to the example method. The example method includes obtaining (Block S146), such as via notification unit 28, processing circuitry 68, processor 70, communication interface 60 and/or radio interface 62, an indication of at least one WD capability, the at least one WD capability comprising a WD-based positioning capability and a minimization of drive test (MDT) capability. The method includes notifying (Block S148), such as via notification unit 28, processing circuitry 68, processor 70, communication interface 60 and/or radio interface 62, at least one other network node about the indicated at least one WD capability.

In some embodiments, the at least one other network node comprises a radio access network (RAN) node and an operations and maintenance (OAM) node. In some embodiments, the positioning report is configured to include WD positioning measurements if the WD indicates that the WD is capable of WD-based positioning and/or MDT reporting. In some embodiments, the indication of the at least one WD capability is associated to the WD's International Mobile Subscriber Identity (IMSI). In some embodiments, the positioning report includes at least one MDT log.

FIG. 11 is a flowchart of an exemplary process in a network node 16 (e.g., OAM, ORAN) according to some embodiments of the present disclosure. One or more Blocks and/or functions and/or methods performed by the network node 16 may be performed by one or more elements of network node 16 such as by configuration unit 36 in processing circuitry 68, processor 70, radio interface 62, etc. according to the example method. The example method includes obtaining (Block S150), such as via configuration unit 36, processing circuitry 68, processor 70, communication interface 60 and/or radio interface 62, an indication of at least one WD capability, the at least one WD capability comprising a WD-based positioning capability and a minimization of drive test (MDT) capability. The method includes configuring (Block S152), such as via configuration unit 36, processing circuitry 68, processor 70, communication interface 60 and/or radio interface 62, the WD 22 with a positioning report based at least in part on the at least one WD capability.

In some embodiments, the method further includes receiving, such as via configuration unit 36, processing circuitry 68, processor 70, communication interface 60 and/or radio interface 62, the WD's location information including the configured positioning report. In some embodiments, the method further includes determining, such as via configuration unit 36, processing circuitry 68, processor 70, communication interface 60 and/or radio interface 62, a radio access network (RAN) node serving the WD 22. In some embodiments, the positioning report is configured to include WD positioning measurements if the WD 22 indicates that the WD 22 is capable of WD-based positioning and/or MDT reporting. In some embodiments, the indication of the at least one WD capability is associated to the WD's International Mobile Subscriber Identity (IMSI). In some embodiments, the positioning report includes at least one MDT log.

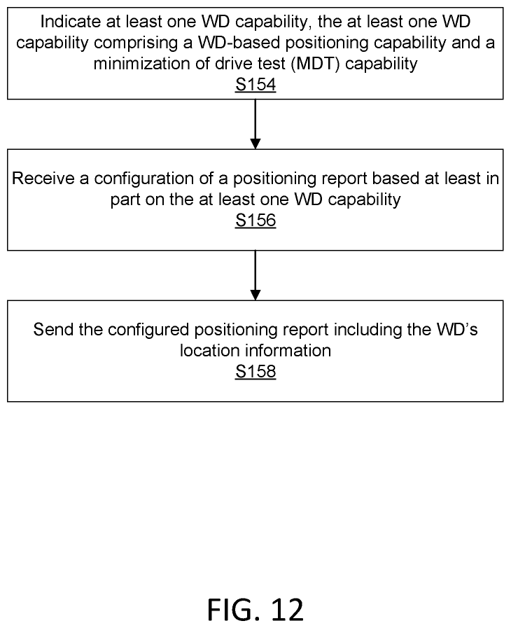

FIG. 12 is a flowchart of an exemplary process in a wireless device 22 according to some embodiments of the present disclosure. One or more Blocks and/or functions and/or methods performed by WD 22 may be performed by one or more elements of WD 22 such as by provider unit 34 in processing circuitry 84, processor 86, radio interface 82, etc. The example method includes indicating/sending (Block S154), such as via provider unit 34, processing circuitry 84, processor 86 and/or radio interface 82, at least one WD capability, the at least one WD capability comprising a WD-based positioning capability and a minimization of drive test (MDT) capability. The method includes receiving (Block S156), such as via provider unit 34, processing circuitry 84, processor 86 and/or radio interface 82, a configuration of a positioning report based at least in part on the at least one WD capability. The method includes sending (Block S158), such as via provider unit 34, processing circuitry 84, processor 86 and/or radio interface 82, the configured positioning report including the WD's 22 location information.

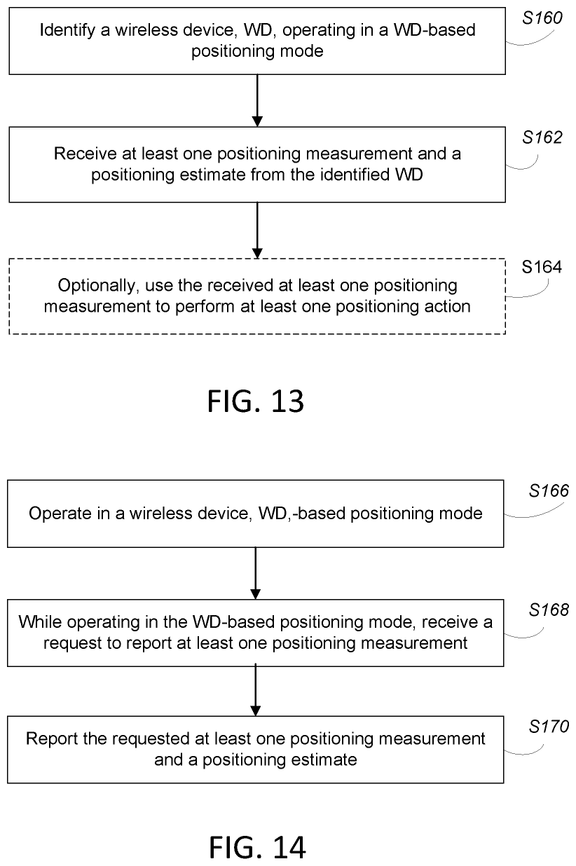

FIG. 13 is a flowchart of an exemplary process in a network node 16 (e.g., LMF, OAM, ORAN) according to some embodiments of the present disclosure. One or more Blocks and/or functions and/or methods performed by the network node 16 may be performed by one or more elements of network node 16 such as by notification unit 28, requestor unit 32 and/or configuration unit 30 in processing circuitry 68, processor 70, communication interface 60, radio interface 62, etc. according to the example method. The example method includes identifying (Block S160), such as by notification unit 28, requestor unit 32 and/or configuration unit 30 in processing circuitry 68, processor 70, communication interface 60 and/or radio interface 62, a wireless device, WD, operating in a WD-based positioning mode. The method includes receiving (Block S162), such as by notification unit 28, requestor unit 32 and/or configuration unit 30 in processing circuitry 68, processor 70, communication interface 60 and/or radio interface 62, at least one positioning measurement and a positioning estimate from the identified WD. The method includes optionally, using (Block S164), such as by notification unit 28, requestor unit 32 and/or configuration unit 30 in processing circuitry 68, processor 70, communication interface 60 and/or radio interface 62, the received at least one positioning measurement to perform at least one positioning action.

In some embodiments, the method further includes sending, such as by notification unit 28, requestor unit 32 and/or configuration unit 30 in processing circuitry 68, processor 70, communication interface 60 and/or radio interface 62, a location information request to the WD, the location information request requesting the at least one positioning measurement and the positioning estimate from the WD operating in the WD-based positioning mode. In some embodiments, the network node 16 comprises a location management function, LMF. In some embodiments, the location information request includes a location information type, the location information type instructing the WD operating in the WD-based positioning mode to report the requested at least one positioning measurement. In some embodiments, the location information type instructs the WD operating in the WD-based positioning mode to report both the at least one positioning measurement and the positioning estimate.

In some embodiments, the method further includes receiving, such as by notification unit 28, requestor unit 32 and/or configuration unit 30 in processing circuitry 68, processor 70, communication interface 60 and/or radio interface 62, the at least one positioning measurement and the positioning estimate from the WD as a result of the location information request. In some embodiments, the method further includes configuring, such as by notification unit 28, requestor unit 32 and/or configuration unit 30 in processing circuitry 68, processor 70, communication interface 60 and/or radio interface 62, the identified WD 22 to perform a minimization of drive test, MDT, logging. In some embodiments, the network node 16 is an operations and maintenance, OAM, network node.

In some embodiments, configuring the WD 22 to perform MDT logging further comprises configuring, such as by notification unit 28, requestor unit 32 and/or configuration unit 30 in processing circuitry 68, processor 70, communication interface 60 and/or radio interface 62, the WD 22 to include at least one positioning measurement from the MDT logging in a positioning report. In some embodiments, the method further includes receiving, such as by notification unit 28, requestor unit 32 and/or configuration unit 30 in processing circuitry 68, processor 70, communication interface 60 and/or radio interface 62, the positioning report comprising the at least one positioning measurement from the WD operating in the WD-based positioning mode.

FIG. 14 is a flowchart of an exemplary process in a wireless device 22 according to some embodiments of the present disclosure. One or more Blocks and/or functions and/or methods performed by WD 22 may be performed by one or more elements of WD 22 such as by provider unit 34 in processing circuitry 84, processor 86, radio interface 82, etc. The example method includes operating (Block S166), such as by provider unit 34 in processing circuitry 84, processor 86 and/or radio interface 82, in a WD-based positioning mode. The method includes while operating the WD-based positioning mode, receiving (Block S168), such as by provider unit 34 in processing circuitry 84, processor 86 and/or radio interface 82, a request to report at least one positioning measurement. The method includes reporting (Block S170), such as by provider unit 34 in processing circuitry 84, processor 86 and/or radio interface 82, the requested at least one positioning measurement and a positioning estimate.

In some embodiments, receiving the request comprises receiving, such as by provider unit 34 in processing circuitry 84, processor 86 and/or radio interface 82, a location information request to the WD 22, the location information request requesting the at least one positioning measurement and the positioning estimate from the WD 22 operating in the WD-based positioning mode. In some embodiments, receiving the request to report the at least one positioning measurement from a location management function, LMF, network node. In some embodiments, the location information request includes a location information type, the location information type instructing the WD 22 operating in the WD-based positioning mode to report the requested at least one positioning measurement. In some embodiments, the location information type instructs the WD 22 operating in the WD-based positioning mode to report both the at least one positioning measurement and the positioning estimate.

In some embodiments, the method further includes performing, such as by provider unit 34 in processing circuitry 84, processor 86 and/or radio interface 82, the at least one positioning measurement; and calculating, such as by provider unit 34 in processing circuitry 84, processor 86 and/or radio interface 82, the positioning estimate for the WD 22 based at least in part on the at least one positioning measurement. In some embodiments, the method further includes receiving, such as by provider unit 34 in processing circuitry 84, processor 86 and/or radio interface 82, a configuration to perform a minimization of drive test, MDT, logging. In some embodiments, receiving the configuration to perform the MDT logging from an operations and maintenance, OAM, network node.

In some embodiments, the configuration instructs the WD 22 to include at least one positioning measurement from the MDT logging in a positioning report. In some embodiments, reporting further comprises sending, such as by provider unit 34 in processing circuitry 84, processor 86 and/or radio interface 82, the positioning report comprising the at least one positioning measurement from the MDT logging.

In some embodiments, the positioning report is configured to include WD positioning measurements if the WD indicates that the WD is capable of WD-based positioning and/or MDT reporting. In some embodiments, the positioning report includes at least one MDT log.

Having described the general process flow of arrangements of the disclosure and having provided examples of hardware and software arrangements for implementing the processes and functions of the disclosure, the sections below provide details and examples of arrangements to retrieve measurements from a wireless device (WD) operating in a WD-based mode and configuration and reporting of measurement results and location calculations for wireless device (WD) based positioning, which may be implemented by the network node 16, wireless device 22 and/or host computer 24.

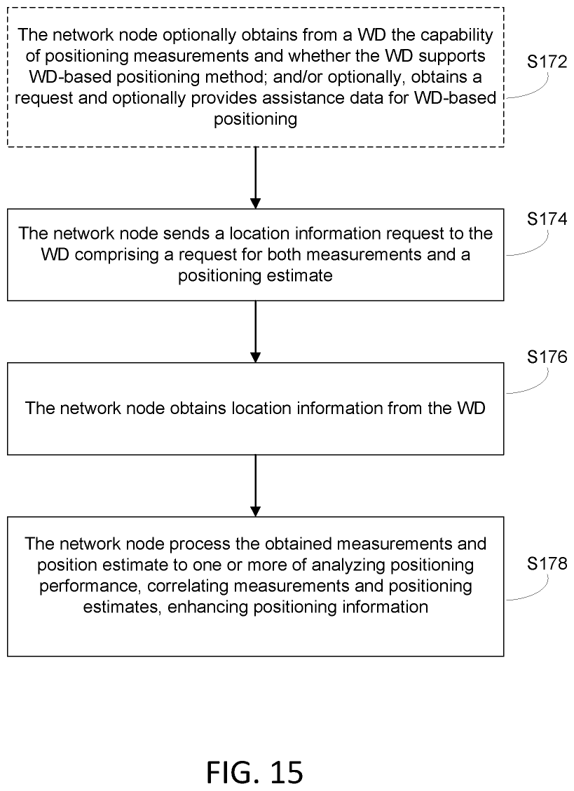

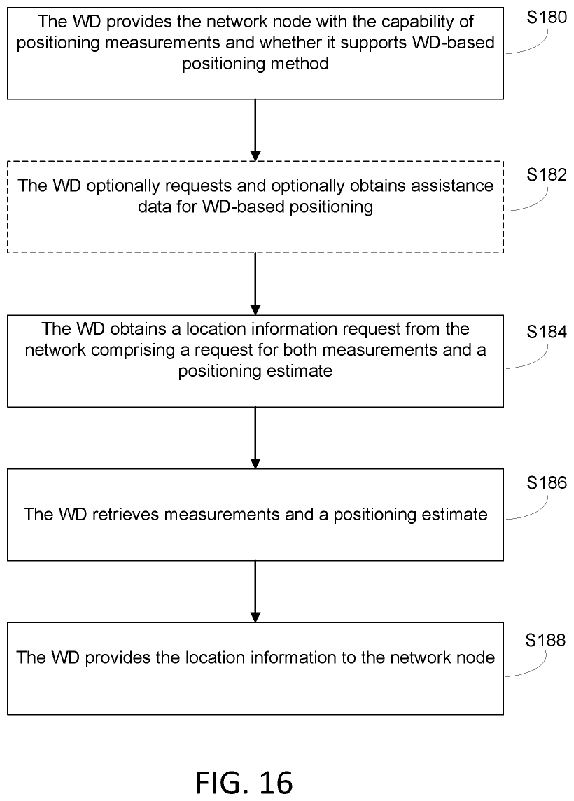

In some embodiments of the present disclosure, a signaling mechanism is provided between the location server (e.g., network node 16) and WD 22, which may enable the retrieval of measurements and positioning estimates from the WD 22. Examples are illustrated by FIGS. 15 and 16, for example.

FIG. 15 illustrates example steps of some embodiments of the present disclosure, from the perspective of the network node 16. The network node 16 optionally obtains (step S172) capabilities (e.g., WD 22 capability of positioning measurements and whether the WD 22 supports WD-based positioning) from the wireless device 22, optionally upon request and/or optionally provides assistance data, optionally upon request by the wireless device 22. Optionally, based on the obtained capabilities and/or the assistance data scope, the network node 16 sends (step S174) a location information request to the wireless device 22, the request comprising a request for both measurements and a position estimate. The scope of the measurements may be detailed via a specific configuration (e.g., RRC). The scope of the position estimate may be detailed via a specific configuration (e.g., RRC). The network node 16 obtains (step S176) location information from the wireless device 22, and the network node 16 processes (step S178) the obtained measurements and position estimate in order to accomplish one or more of analyzing positioning performance, correlating measurements and position estimate, enhancing positioning information in the network node 16.

FIG. 16 illustrates example steps of some embodiments of the present disclosure, from the perspective of the wireless device 22. The wireless device 22 optionally provides (step S180) capabilities (e.g., WD 22 capability of positioning measurements and whether the WD 22 supports WD-based positioning) to the network node 16, optionally upon request by the network node 16. The wireless device 22 (step S182) optionally obtains assistance data from the network node 16, optionally upon request by the wireless device 22. Optionally, the wireless device 22 obtains from the network node 16 (step S184) a location information request comprising a request for both measurements and a position estimate. The scope of the measurements may be detailed via a specific configuration (e.g., RRC). The scope of the position estimate may be detailed via a specific configuration (e.g., RRC). The wireless device 22 retrieves (step S186) measurements and a position estimate from internal procedures. The wireless device 22 provides (step S188) location information to the network node 16, comprising measurements and a position estimate.

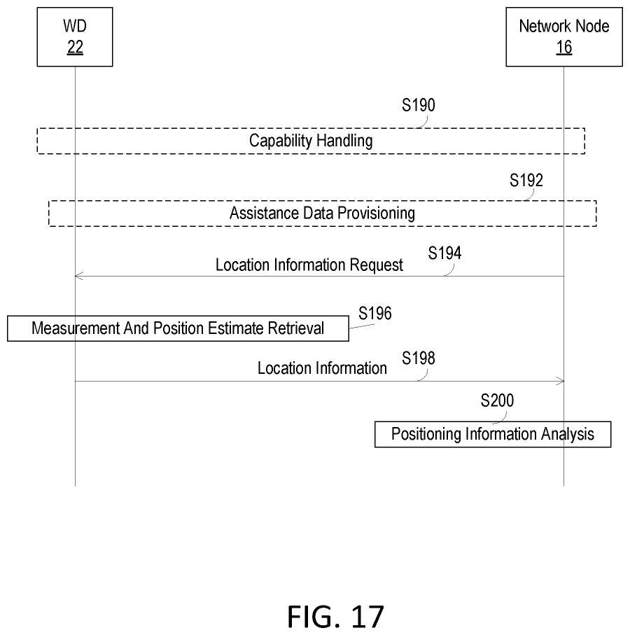

FIG. 17 provides an example signaling chart, where the wireless device 22 and network node 16 optionally engage in capability handling signaling (step S190) and optionally engage in assistance data provisioning (step S192). The network node 16 sends a location information request (step S194) comprising a request for both measurements and a position estimate. The wireless device 22 retrieves (step S196) measurements and a position estimate from internal procedures. For example, WD 22 may perform measurements on e.g., positioning reference signals and may use the measurements to estimate and/or calculate the WD's 22 position. The wireless device 22 provides (step S198) location information to the network node 16, comprising measurements and a position estimate. Based on the obtained Information, the network node 16 processes (step S200) the obtained measurements and position estimate in order to accomplish a positioning action which may include one or more of analyzing positioning performance, correlating measurements and position estimate, enhancing positioning information in the network node 16.

Location Information Request

In some embodiments, the location information request (e.g., steps S172 and S182) may include a dedicated location information type to instruct the wireless device 22 to report both measurements and a location estimate to the network node 16. If this is not possible, the wireless device 22 may be instructed to provide an error message indicating the reasons why the requested information is not able to be reported.

In one embodiment, a new item may be added in the following structure: commonIEsRequestLocationInformation, to indicate to the WD 22 that the location server (e.g., network node 16) requests the location estimate and measurements.

In one aspect of this embodiment, the location server (e.g., network node 16) may also indicate the reason as why it wants the information. It can be for radio network management reasons, for integrity reasons (cross verification and reliability), for database generation, etc.

The field commonIEsRequestLocationInformation specifies the location information type requested by the location server (e.g., network node 16) and optionally other configuration information associated with the requested location information. This field may always be included in this version of the protocol.

With respect to draft 3GPP Technical Specification (TS) 37.355 version 16.0.0, an example of the change is shown in bold.

CommonIEsRequestLocationInformation

The CommonIEsRequestLocationInformation carries common IEs for a Request Location Information LPP message Type.

-- ASN1START
CommonIEsRequestLocationInformation ::= SEQUENCE {

| locationInformationType | LocationInformationType, | |
|---|---|---|
| triggeredReporting | TriggeredReportingCriteria | OPTIONAL, -- |

Cond ECID

| | |
|---|---|
| periodicalReporting | PeriodicalReportingCriteria OPTIONAL, -- |

Need ON

| additionalInformation | | OPTIONAL, -- Need ON |
|---|---|---|
| qos | | QoS |
| | OPTIONAL, -- Need ON | |
| environment | | Environment |

OPTIONAL, -- Need ON

| locationCoordinateTypes | OPTIONAL, -- Need ON | |
|---|---|---|
| velocityTypes | | OPTIONAL, -- |

```
Need ON
  ...,
  [[
```

| | |
|---|---|
| messageSizeLimitNB-r14 | MessageSizeLimitNB-r14 |

```
  OPTIONAL -- Need ON
  ]],
  [[
```

| | |
|---|---|
| segmentationInfo-r14 SegmentationInfo-r14 | OPTIONAL -- Need |

```
ON
  ]]
}
LocationInformationType ::= ENUMERATED {
  locationEstimateRequired,
  locationMeasurementsRequired,
  locationEstimatePreferred,
  locationMeasurementsPreferred,
  ...,
  [[
  locationEsitimateAndMeasurementsRequired-v16xy
  ]]
}
```

| PeriodicalReportingCriteria ::= | SEQUENCE { | |
|---|---|---|
| reportingAmount | ENUMERATED { | |
| | | ra1, ra2, |
| ra4, ra8, ra16, ra32, | | |
| | | ra64, ra- |

Infinity

} DEFAULT ra-

Infinity,

| | |
|---|---|
| reportingInterval | ENUMERATED { |

noPeriodicalReporting, ri0-25,

ri0-5, ri1,

ri2, ri4, ri8, ri16, ri32, ri64

}

}

| TriggeredReportingCriteria ::= | SEQUENCE { |
|---|---|
| cellChange | BOOLEAN, |

| | |
|---|---|
| reportingDuration | , |

...
}

| | |
|---|---|
| ReportingDuration ::= | INTEGER (0..255) |

```
AdditionalInformation ::= ENUMERATED {
  onlyReturnInformationRequested,
  mayReturnAditionalInformation,
  ...
}
QoS ::= SEQUENCE {
```

| | | |
|---|---|---|
| horizontalAccuracy | HorizontalAccuracy | OPTIONAL, -- |

Need ON

| | | | |
|---|---|---|---|
| verticalCoordinateRequest | BOOLEAN, | | |
| verticalAccuracy | | VerticalAccuracy | OPTIONAL, -- |

Need ON

| | | |
|---|---|---|
| responseTime | ResponseTime | OPTIONAL, -- |

Need ON

| | |
|---|---|
| velocityRequest | BOOLEAN, |

...,

| | | | |
|---|---|---|---|
| [[ | responseTimeNB-r14 | ResponseTimeNB-r14 | OPTIONAL -- |

Need ON
]],

| | | |
|---|---|---|
| [[ | horizontalAccuracyExt-r15 | HorizontalAccuracyExt-r15 |

OPTIONAL, -- Need ON

| | |
|---|---|
| verticalAccuracyExt-r15 | Vertical AccuracyExt-r15 |

```
  OPTIONAL -- Need ON
  ]]
}
HorizontalAccuracy ::= SEQUENCE {
```

| | |
|---|---|
| accuracy | INTEGER(0..127), |
| confidence | INTEGER(0..100), |

...
}
VerticalAccuracy ::= SEQUENCE {

| | |
|---|---|
| accuracy | INTEGER(0..127), |
| confidence | INTEGER(0..100), |

...
}
HorizontalAccuracyExt-r15 ::= SEQUENCE {

| | |
|---|---|
| accuracyExt-r15 | INTEGER(0..255), |
| confidence-r15 | INTEGER(0..100), |

...
}
VerticalAccuracyExt-r15 ::= SEQUENCE {

| | |
|---|---|
| accuracyExt-r15 | INTEGER(0..255), |
| confidence-r15 | INTEGER(0..100), |

...
}
ResponseTime ::= SEQUENCE {

| | |
|---|---|
| time | INTEGER (1..128), |

...,

| | | |
|---|---|---|
| [[ | responseTimeEarlyFix-r12 | INTEGER (1..128) |

| | |
|---|---|
| OPTIONAL | -- Need ON |

]],

| | | |
|---|---|---|
| [[ | unit-r15 | ENUMERATED { ten-seconds, ... } |

| | |
|---|---|
| OPTIONAL | -- Need ON |

]]
}
ResponseTimeNB-r14 ::= SEQUENCE {

| | |
|---|---|
| timeNB-r14 | INTEGER (1..512), |
| responseTimeEarlyFixNB-r14 | INTEGER (1..512) |

| | |
|---|---|
| OPTIONAL, | -- Need ON |

...,

| | | |
|---|---|---|
| [[ | unitNB-r15 | ENUMERATED { ten-seconds, ... } |

| | |
|---|---|
| OPTIONAL | -- Need ON |

```
  ]]
}
Environment ::= ENUMERATED {
  badArea,
  notBadArea,
  mixedArea,
  ...
}
MessageSizeLimitNB-r14 ::= SEQUENCE {
```

| | |
|---|---|
| measurementLimit-r14 | INTEGER (1..512) |

| | |
|---|---|
| OPTIONAL, | -- Need ON |

...
}
-- ASN1STOP

| Conditional | |
|---|---|
| presence | Explanation |
| ECID | The field is optionally present, need ON, if ECID is |
| | requested. Otherwise it is not present. |

CommonIEsRequestLocationInformation field descriptions

locationInformationType
This information element (IE) indicates whether the server requires a location estimate or
measurements. For ‘locationEstimateRequired’, the target device returns a location estimate if
possible, or indicate a location error if not possible. For ‘locationMeasurementsRequired’, the
target device returns measurements if possible, or indicate a location error if not possible. For
‘locationEstimatePreferred’, the target device returns a location estimate if possible, but may also
or instead return measurements for any requested position methods for which a location estimate
is not possible. For ‘locationMeasurementsPreferred’, the target device returns location
measurements if possible, but may also or instead return a location estimate for any requested
position methods for which return of location measurements is not possible. For
‘locationEstimateAndMeasurementsRequired’, the target device returns a location estimate and
measurements if possible, or indicate an error if not possible.

Furthermore, in one embodiment, the type of measurements to be provided is detailed in specific location information requests per positioning method. Non-limiting examples of positioning methods include Enhanced Cell ID (E-CID), OTDOA, A-GNSS, DL-TDOA, Multi-RTT (round trip time), AoD, Bluetooth, wireless local area network (WLAN), Sensors, transport block size (TBS), etc. By separating the request for specific measurements per positioning method, the existing mechanisms for requesting measurements as part of normal WD-assisted positioning may be utilized.

In another embodiment, specific requests for specific measurements to be included with the request for location estimate and measurements are considered. In one example, the requested measurements are signal strength/quality measurements per beam/resource/resource set/synchronization signal block/cell.

Provide Location Information (e.g., blocks S176, S188)

In one preferred embodiment, the wireless device 22 uses the existing CommonIEsProvideLocationInformation structure to provide the location estimate to the network node 16 and the provided location information structure per positioning method to provide the measurements. The wireless device 22 provides measurements as requested (e.g., in steps S174 and S184) in the request for location information.

In cases where the requested information cannot be provided, the wireless device 22 indicates an error. As a baseline, the existing target wireless device error causes per positioning method or the common error causes are used e.g., by the wireless device 22 to indicate the error. In addition, there can be dedicated error causes associated to the combination of location estimates and measurements.

Triggering the Request for Location Estimate and Measurements (e.g., Blocks S174 and S184)

One use case is radio access network (RAN) resource management use case. For example, a gNB (e.g., network node 16) is transmitting PRS. From an operator perspective, it may be useful to understand the PRS utilization. The network (e.g., network node 16) may collect measurements from the WD 22 during different occasions (peak traffic hour, low traffic hour, etc.).

In some embodiments, there can be positioning integrity related use cases; where it may be useful that both the LMF (e.g., network node 16) and WD 22 calculate the WD 22 position.

In some embodiments, there may be occasional positioning measurement sampling from the network (e.g., network node 16). If the WD 22 is performing periodic measurements, the network (e.g., network node 16) may invoke the retrieval once every X interval; where X can be for example a time duration in milliseconds or seconds.

Triggering Location Information Provisioning

In some embodiments, the requested provided location information can be triggered by the network node 16 request (e.g., blocks S174 and S184), or can be sent by the WD 22 unsolicited by the network.

Some embodiments provide for arrangements to allow the network node 16 to be able to collect the measurements for radio access technology (RAT)-dependent WD-based positioning for methods such as DL-TDOA and DL-AoD (RSTD, PRS RSRP measurements) from WD-based WDs 22 which would otherwise not be possible; as WD 22 is not mandated to provide these values as would have been done by WDs 22 operating in WD-assisted mode.

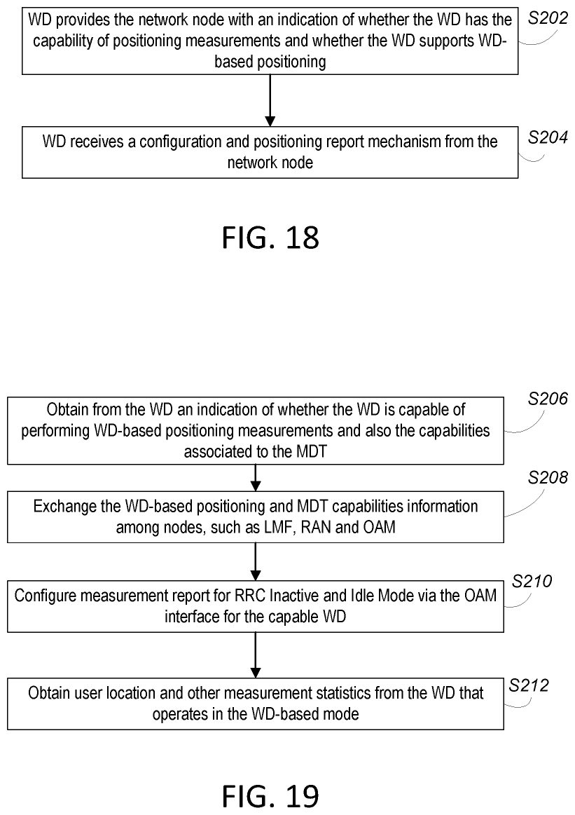

FIG. 18 is a flowchart illustrating an embodiment from the perspective of the WD 22. In one embodiment, the WD 22 may perform one or more of the following steps:
providing (S202) the network node 16 with the capability of positioning measurements and whether the WD 22 supports WD-based positioning; and
receiving (S204) a configuration and positioning measurement reporting mechanisms from the network.

FIG. 19 is a flowchart illustrating an embodiment from a network node 16 perspective. In one embodiment, the network node 16 may perform one or more of the following steps:
obtaining (S206) the capability from the WD 22 as to whether the WD 22 is capable of performing the WD-based positioning measurements and also the capabilities associated to the MDT;
exchanging (S208) the WD-based positioning and MDT capabilities information among network nodes such as the LMF, RAN and OAM;
configuring (S210) a measurement report for RRC Inactive and Idle mode via the OAM interface for such capable WD 22; and
obtaining (S212) user location and other measurement statistics from the WD 22 that operates in the WD-based mode.

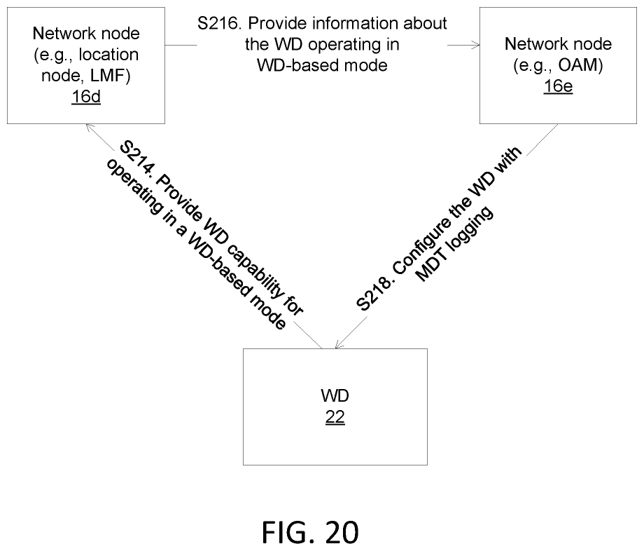

FIG. 20 is a schematic diagram illustrating an example interaction between the WD 22, network node 16d (e.g., LMF) and network node 16e (e.g., OAM) for e.g., configuration for a WD-based RAT dependent positioning arrangement. In step S214, the WD 22 provides WD capability for operating in a WD-based positioning mode. In step S216, the network node (e.g., LMF) provides information about the WD 22 operating in the WD-based mode. In step S218, the network node 16e (e.g., OAM, ORAN) configures the WD with MDT logging.

One embodiment provides that an interface (e.g., interface 23) between network node 16d (e.g., LMF) and network node 16e (e.g., OAM) may be defined which exchanges the information regarding the WDs 22 which are performing or capable of performing the WD-based positioning method. The network node 16e (e.g., OAM) may select such WD 22 for MDT/SON.

In another embodiment, it is provided that a WD 22 that is configured with WD-based positioning method and the MDT configuration may include location information as part of the MDT report. In some embodiments, the report (e.g., MDT report) may include one or more of the following information: beam/cells used for measurements, DL-PRS RSRP, RSTD, Location estimates, timestamp, TOA, WD RxTx, etc.

### WD Identifier Related Embodiments

In some embodiments, the network node 16d (e.g., LMF) is aware of only the T-IMSI (International Mobile Subscriber Identity) associated to the WD 22. In this scenario, when the network node 16d (e.g., LMF) informs the network node 16e (e.g., OAM) about the configuration of WD-based positioning for a WD 22 as identified using the T-, there can be different actions taken by the network node 16e (e.g., OAM) depending on whether signaling-based MDT or the management-based MDT is to be configured.

Signaling-Based MDT:

If the signaling-based MDT is to be configured, then the network node 16e (e.g., OAM) may request the MME/AMF (e.g., network node 16f) to configure the same WD 22 with the signaling-based MDT configuration. The network node 16e (e.g., OAM) may send the T-IMSI in such a request message and using this T-IMSI, the MME/AMF (e.g., network node 16f) may identify the RAN node (e.g., network node 16a) that is serving this WD 22 and may request the RAN node (e.g., network node 16a) to perform/configure the signaling-based MDT towards the WD 22. The MME/AMF (e.g., network node 16f) may further assist the network node 16e (e.g., OAM) to map the received MDT report with the WDs 22 unique identifier.

Management-Based MDT:

If the management-based MDT is to be configured, there can be at least two scenarios, for example

a. If the network node 16e (e.g., OAM, ORAN) is unaware of the RAN node (e.g., network node 16a) serving the WD 22, then the network node 16e (e.g., OAM, ORAN) requests the network node 16f (e.g., mobility management node, MME/AMF) to report the RAN node (e.g., network node 16a) that is currently serving the WD 22. In the request message, the network node 16e (e.g., OAM, ORAN) includes the T-IMSI based on which the network node 16f (e.g., mobility management node, MME/AMF) informs the RAN node (e.g., network node 16a) that is currently handling the WD 22. Then the network node 16e (e.g., OAM, ORAN) may request said RAN node (e.g., network node 16a) to configure the management-based MDT knowing that there is a large probability that the WD 22 selection performed by the RAN node (e.g., network node 16a) may end-up configuring the WD 22 that has already been configured with WD-based positioning.

b. If the network node 16e (e.g., OAM, ORAN) is aware of the RAN node (e.g., network node 16a) serving the WD 22, then the network node 16e (e.g., OAM, ORAN) may directly request the RAN node (e.g., network node 16a) to configure the management-based MDT knowing that there is a large probability that the WD 22 selection performed by the RAN node (e.g., network node 16a) may end-up configuring the WD 22 that has already been configured with WD-based positioning.

The following section discusses the embodiments when the LMF is aware of the IMSI/MSIDN/IMEI associated with the WD 22. In this scenario, when the LMF informs the network node 16e (e.g., OAM, ORAN) about the configuration of WD-based positioning for a WD 22 as identified using for example the IMSI, there can be different actions taken by the network node 16e (e.g., OAM, ORAN) depending on whether the signaling-based MDT or the management-based MDT is to be configured to the WD 22.

1) FIG. 14 illustrates an example in which the signaling-based MDT is to be configured for the WD 22. The network node 16e (e.g., OAM, ORAN) requests the network node 16f (e.g., mobility management node, MME/AMF) to configure the same WD 22 with signaling-based MDT configuration. The network node 16e (e.g., OAM, ORAN) sends the IMSI in such a request message and using this IMSI, the network node 16f (e.g., mobility management node, MME/AMF) may identify the RAN node (e.g., network node 16a) that is serving this WD 22 and requests the RAN node (e.g., network node 16a) to perform/configure the signaling-based MDT towards the WD 22.

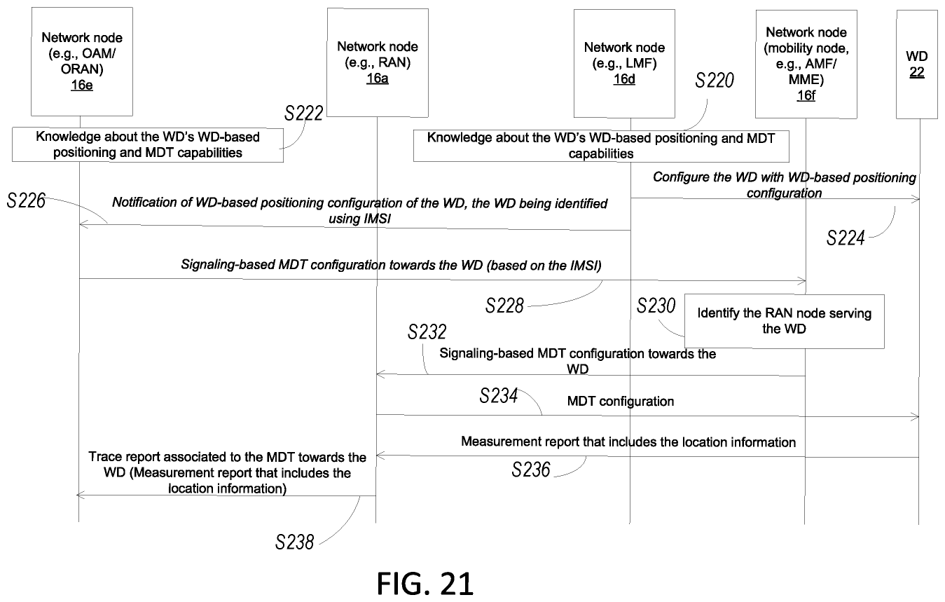

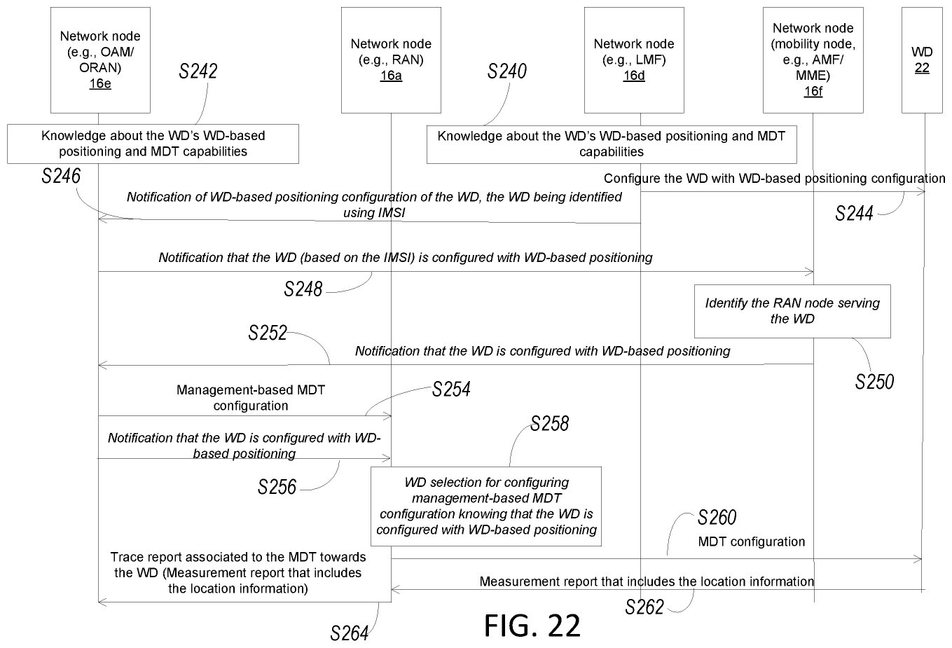

In FIG. 21, in step S220 and step S222, the network nodes 16d and 16e, respectively, obtain knowledge about the WD's 22 WD-based positioning and MDT capabilities. In step S224, the WD 22 is configured with WD-based positioning configuration. In step S226, network node 16d (e.g., LMF) notifies network node 16e (e.g., OAM/ORAN) of the WD-based positioning configuration, the WD 22 being identified using IMSI. In step S228, network node 16e (e.g., OAM/ORAN) provides signaling-based MDT configuration towards the WD (based on the IMSI). In step S230, the RAN node (e.g., network node 16a) serving the WD 22 is identified. In step S232, a signaling-based MDT configuration is sent towards the WD 22. In step S234, the RAN node (e.g., network node 16a) sends the MDT configuration to the WD 22. In step S236, the WD 22 sends the measurement report. In step S238, a trace report associated to the MDT towards the WD 22 is sent.

2) If the management-based MDT is to be configured, there can be two scenarios:

a. If the network node 16e (e.g., OAM, ORAN) is unaware of the RAN node (e.g., network node 16a) serving the WD 22:

i. In some embodiments, the network node 16e (e.g., OAM, ORAN) requests the network node 16f (e.g., mobility management node, MME/AMF) to report the RAN node (e.g., network node 16a) that is currently serving the WD 22. In the request message, the network node 16e (e.g., OAM, ORAN) includes the IMSI based on which the network node 16f (e.g., mobility management node, MME/AMF) informs the RAN node (e.g., network node 16a) that is currently handling the WD 22. Once the network node 16e (e.g., OAM, ORAN) is aware of the RAN node (e.g., network node 16a) that is serving the WD 22, the network node 16e (e.g., OAM, ORAN) can inform the RAN node (e.g., network node 16a) that the WD 22 has been configured with the WD-based positioning method. Based on this the RAN node (e.g., network node 16a) can select those WDs 22 which are already configured with WD-based positioning method to also perform the MDT measurements as these WDs 22 may include the location information as part of the MDT logs.

In FIG. 15, in step S240 and step S242, the network nodes 16d and 16e, respectively, obtain knowledge about the WD's 22 WD-based positioning and MDT capabilities. In step S244, the WD 22 is configured with WD-based positioning configuration. In step S246, network node 16d (e.g., LMF) notifies network node 16e (e.g., OAM/ORAN) of the WD-based positioning configuration, the WD 22 being identified using IMSI. In step S248, network node 16e (e.g., OAM/ORAN) notifies that the WD 22 (based on the IMSI) is configured with WD-based positioning. In step S250, the RAN node (e.g., network node 16a) serving the WD 22 is identified. In step S252, network node 16f (e.g., mobility management node) notifies that the WD is configured with WD-based positioning. In step S254, network node 16e (e.g., OAM, ORAN) sends a management-based MDT configuration. In step S256, a notification that the WD 22 is configured with WD-based positioning is sent. In step S258, network node 16a (e.g., RAN node) performs WD selection for configuring management-based MDT configuration knowing that the WD 22 is configured with WD-based positioning. In step S260, an MDT configuration is sent to the WD 22. In step S262, the WD 22 sends the measurement report. In step S264, a trace report associated to the MDT towards the WD 22 is sent.

ii. In some other embodiments, the network node 16e (e.g., OAM, ORAN) requests the network node 16f (e.g., mobility management node, MME/AMF) to directly let the RAN node (e.g., network node 16a) associated to this WD 22, as identified using the IMSI, that the WD 22 has been configured with the WD-based positioning method. If the RAN node (e.g., network node 16a) that receives this information from the network node 16f (e.g., mobility management node, MME/AMF) has been configured with management-based MDT then the RAN node (e.g., network node 16a) can select those WDs 22 which are already configured with WD-based positioning method to also perform the MDT measurements as these WDs 22 may include the location information as part of the MDT logs.

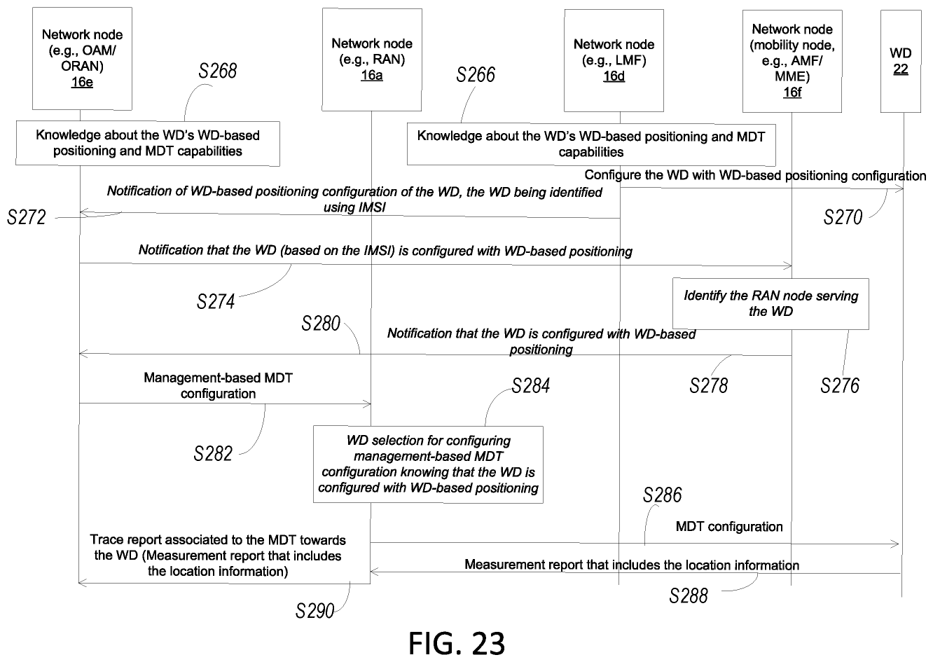

In FIG. 23, in step S66 and step S268, the network nodes 16d and 16e, respectively, obtain knowledge about the WD's 22 WD-based positioning and MDT capabilities. In step S270, the WD 22 is configured with WD-based positioning configuration. In step S272, network node 16d (e.g., LMF) notifies network node 16e (e.g., OAM/ORAN) of the WD-based positioning configuration, the WD 22 being identified using IMSI. In step S274, network node 16e (e.g., OAM/ORAN) notifies that the WD (based on the IMSI) is configured with WD-based positioning. In step S276, the RAN node (e.g., network node 16a) serving the WD 22 is identified. In step S278, network node 16f (e.g., mobility management node) notifies that the WD 22 is configured with WD-based positioning. In step S280, network node 16e (e.g., OAM, ORAN) sends a notification that the WD 22 is configured with WD-based positioning. In step S282, a management-based MDT configuration is sent towards the WD 22. In step S284, network node 16a (e.g., RAN node) performs WD selection for configuring management-based MDT configuration knowing that the WD 22 is configured with WD-based positioning. In step S286, an MDT configuration is sent to the WD 22. In step S288, the WD 22 sends the measurement report. In step S290, a trace report associated to the MDT towards the WD 22 is sent.

b. If the network node 16e (e.g., OAM, ORAN) is aware of the RAN node (e.g., network node 16a) serving the WD 22, then the network node 16e (e.g., OAM, ORAN) directly informs the RAN node (e.g., network node 16a) that the WD 22 is configured with WD-based positioning information. Based on this the RAN node (e.g., network node 16a) may select those WDs 22 which are already configured with WD-based positioning method to also perform the MDT measurements as these WDs 22 may include the location information as part of the MDT logs.

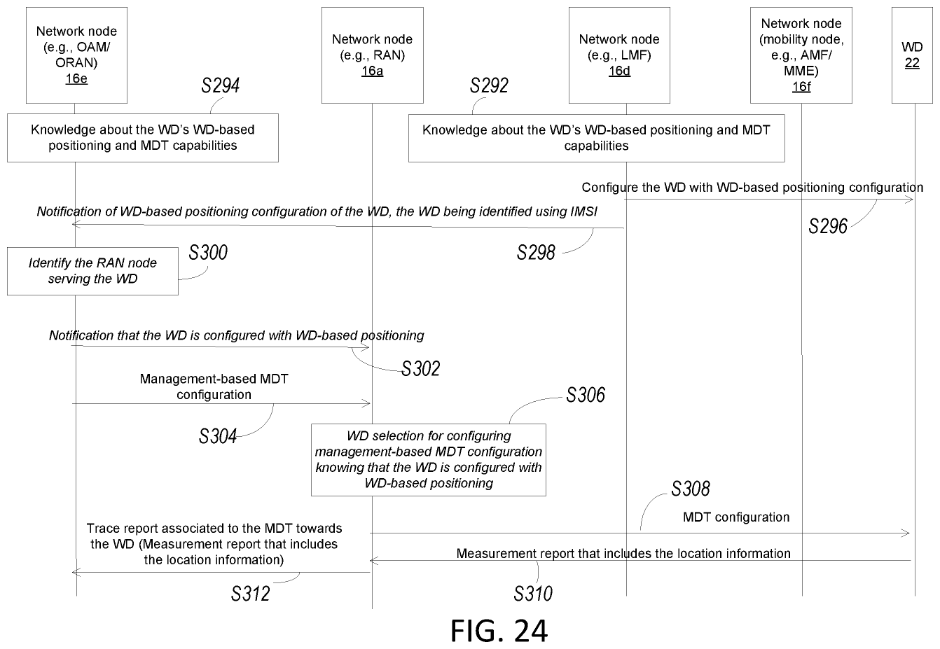

In FIG. 24, in step S292 and step S294, the network nodes 16d and 16e, respectively, obtain knowledge about the WD's 22 WD-based positioning and MDT capabilities. In step S296, the WD 22 is configured with WD-based positioning configuration. In step S298, network node 16d (e.g., LMF) notifies network node 16e (e.g., OAM/ORAN) of the WD-based positioning configuration, the WD 22 being identified using IMSI. In step S300, the RAN node (e.g., network node 16a) serving the WD 22 is identified. In step S302, network node 16e (e.g., OAM, ORAN) notifies that the WD 22 is configured with WD-based positioning. In step S304, network node 16e (e.g., OAM, ORAN) sends a management-based MDT configuration towards the WD 22. In step S306, network node 16a (e.g., RAN node) performs WD selection for configuring management-based MDT configuration knowing that the WD 22 is configured with WD-based positioning. In step S308, an MDT configuration is sent to the WD 22. In step S310, the WD 22 sends the measurement report. In step S312, a trace report associated to the MDT towards the WD 22 is sent.

### Additional Embodiments Related to how the RAN Node Becomes Aware of which WDs 22 are Configured with WD-Based Positioning

In some embodiments, the RAN node (e.g., network node 16a) receives the information regarding the WDs 22 that are configured with WD-based positioning from one of the following methods:

1) From Core network (LMF→OAM→AMF→RAN):
a. Without explicit request from RAN node:
   AMF informs the RAN node as part of WD 22 context setup or as part of the WD 22 related assistance information at a later stage. In this method, the AMF gets to know about this from the network node 16e (e.g., OAM, ORAN) which in turn gets to know from the network node 16d (e.g., positioning node, LMF).
b. With explicit request from the RAN node:
   When the RAN node (e.g., network node 16a) wants to configure the management-based MDT, the RAN node (e.g., network node 16a) requests the AMF to inform if any of the WDs 22 served by the RAN node (e.g., network node 16a) currently have been configured with WD-based positioning method. In this method, the AMF gets to know about this from the network node 16e (e.g., OAM, ORAN) which in turn gets to know from the network node 16d (e.g., positioning node, LMF).

2) From the network node 16e (e.g., OAM, ORAN):
a. Without explicit request from RAN node:
   network node 16e (e.g., OAM, ORAN) informs the RAN node independently when the network node 16e (e.g., OAM, ORAN) becomes aware of a WD 22 that is served by the RAN node (e.g., network node 16a) is configured with the WD-based positioning method. In this method, the network node 16e (e.g., OAM, ORAN) gets to know about such WDs 22 from the network node 16d (e.g., positioning node, LMF) and the network node 16e (e.g., OAM, ORAN) might exchange information with core network to identify which RAN node (e.g., network node 16a) is serving the WD 22.
b. With explicit request from the RAN node:
   When the RAN node (e.g., network node 16a) wants to configure the management-based MDT, the RAN node requests the network node 16e (e.g., OAM, ORAN) to inform if any of the WDs 22 served by the RAN node (e.g., network node 16a) currently have been configured with WD-based positioning method.

3) From the WD 22:
a. Without explicit request from RAN node:
   WD 22 informs the RAN node (e.g., network node 16a) voluntarily either via an RRC message or a medium access control (MAC) control element (CE) or some other way when the WD 22 gets configured with the WD-based positioning method.
b. With explicit request from the RAN node:
   The RAN node (e.g., network node 16a) requests the WD 22 if it is configured with the WD-based positioning method or not for which the WD 22 replies whether it is configured with the WD-based positioning method or not. In some methods, the RAN node (e.g., network node 16a) may request the WD 22 to inform it when the WD 22 is configured with WD-based positioning method and in such methods, upon the network node 16d (e.g., positioning node, LMF) configuring the WD 22, the WD 22 informs the RAN node (e.g., network node 16a) either via an RRC message or a MAC CE or some other way when the WD 22 is configured with the WD-based positioning method.

4) From the network node 16d (e.g., positioning node, LMF):
a. Without explicit request from RAN node:
   network node 16d (e.g., positioning node, LMF) informs the RAN node (e.g., network node 16a) independently when the network node 16d (e.g., positioning node, LMF) becomes aware of a WD 22 that is served by the RAN node is configured with the WD-based positioning method.
b. With explicit request from the RAN node:
   When the RAN node (e.g., network node 16a) wants to configure the management-based MDT, the RAN node (e.g., network node 16a) requests the network node 16d (e.g., positioning node, LMF) to inform if any of the WDs 22 served by the RAN node (e.g., network node 16a) currently have been configured with WD-based positioning method.
c. LMF->AMF->OAM->RAN:
   When the RAN node (e.g., network node 16a) wants to configure the management-based MDT, the RAN node (e.g., network node 16a) requests the AMF to inform if any of the WDs 22 served by the RAN node (e.g., network node 16a) currently have been configured with WD-based positioning method. The AMF interacts with network node 16d (e.g., positioning node, LMF) to provide any information on WDs 22 which are performing WD-based positioning. The network node 16d (e.g., positioning node, LMF) provides the correlation ID for WD-based positioning method. Having correlation ID may make it optional for the network node 16d (e.g., positioning node, LMF) to know the WD 22 Id. The main purpose of the Correlation ID in AMF is used to correlate the procedure between the AMF and the network node 16d (e.g., positioning node, LMF) with the procedure between the AMF and the NG-RAN node (e.g., network node 16a) (the AMF acts as a routing node in this respect). The AMF with the correlation ID and with the NG Application Protocol (NGAP) WD ID identifies the WD ID and informs to network node 16e (e.g., OAM, ORAN).

In this above case 4.b), from the network node 16d (e.g., positioning node, LMF); NRPPa protocol can be used. A new NRPPa procedure may be defined or existing NRPPa procedure (such as Measurement Request/Response, as shown in FIG. 18 for example) may be extended to include also the MDT related information exchange between network node 16d (e.g., positioning node, LMF) and RAN nodes.

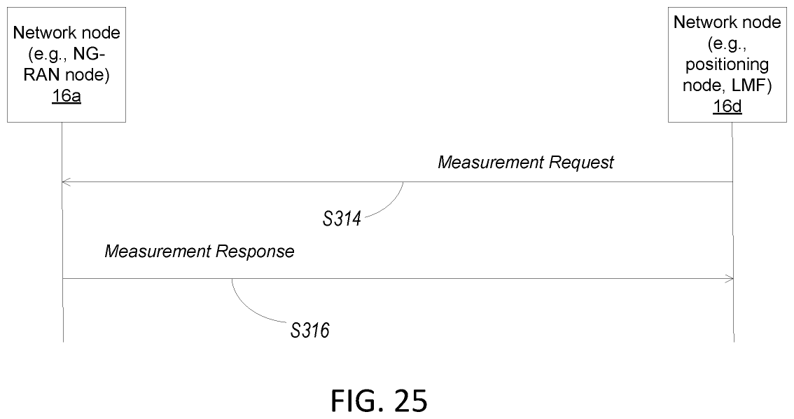

In FIG. 25, the network node 16d (e.g., positioning node, LMF) sends a measurement request in step S314. In step S316, network node 16a (e.g., NG-RAN node) sends a measurement response.

In some embodiments, one motivation is that NW would be able to collect the measurements for RAT dependent WD-based positioning for methods such as DL-TDOA and DL-AoD (RSTD, PRS RSRP measurements) from WD-based WDs 22 which would otherwise not be possible; as WD 22 may not be mandated to provide these values during normal positioning procedures.

Thus, in some embodiments, one objective is to obtain such logs/measurements from MDT.

In some embodiments, one objective then is how to identify WD-based WDs 22 and activate the MDT logging so the NW (e.g., network node 16) can obtain the relevant logs. This may be useful from a NW perspective to obtain the logs to tune/optimize positioning reference signal (PRS) related parameters and to gauge beams/cells PRS transmission utilizations.

Some embodiments may include one or more of the following:

Embodiment A1. A network node configured to communicate with a wireless device (WD), the network node configured to, and/or comprising a radio interface and/or comprising processing circuitry configured to:

send a location information request to the wireless device, the location information request requesting measurements and a positioning estimate from the wireless device;

as a result of the location information request, receive the measurements and the positioning estimate from the wireless device; and

use the received measurements and the positioning estimate to perform at least one positioning action.

Embodiment A2. The network node of Embodiment A1, wherein the location information request includes a location information type, the location information type indicating to the wireless device to report both the measurement and the positioning estimate, or an error if the wireless device is unable to report the measurement and the positioning estimate.

Embodiment A3. The network node of Embodiment A1, wherein the location information request one or more of:

is included in a Long Term Evolution (LTE) positioning protocol (LPP) message; and

indicates a type of measurement per positioning method.

Embodiment B1. A method implemented in a network node, the method comprising:

sending a location information request to the wireless device, the location information request requesting measurements and a positioning estimate from the wireless device;

as a result of the location information request, receiving the measurements and the positioning estimate from the wireless device; and

using the received measurements and the positioning estimate to perform at least one positioning action.

Embodiment B2. The method of Embodiment B1, wherein the location information request includes a location information type, the location information type indicating to the wireless device to report both the measurement and the positioning estimate, or an error if the wireless device is unable to report the measurement and the positioning estimate.

Embodiment B3. The method of Embodiment B1, wherein the location information request one or more of:

is included in a Long Term Evolution (LTE) positioning protocol (LPP) message; and

indicates a type of measurement per positioning method.

Embodiment C1. A wireless device (WD) configured to communicate with a network node, the WD configured to, and/or comprising a radio interface and/or processing circuitry configured to:

receive a location information request from the network node, the location information request requesting measurements and a positioning estimate from the wireless device;

as a result of the location information request, determine the measurements and the positioning estimate; and

send the measurements and the positioning estimate to the network node.

Embodiment C2. The wireless device of Embodiment C1, wherein the location information request includes a location information type, the location information type indicating to the wireless device to report both the measurement and the positioning estimate, or an error if the wireless device is unable to report the measurement and the positioning estimate.

Embodiment C3. The wireless device of Embodiment C1, wherein the location information request one or more of:

is included in a Long Term Evolution (LTE) positioning protocol (LPP) message; and

indicates a type of measurement per positioning method.

Embodiment D1. A method implemented in a wireless device (WD), the method comprising:

receiving a location information request from the network node, the location information request requesting measurements and a positioning estimate from the wireless device;

as a result of the location information request, determining the measurements and the positioning estimate; and

sending the measurements and the positioning estimate to the network node.

Embodiment D2. The method of Embodiment D1, wherein the location information request includes a location information type, the location information type indicating to the wireless device to report both the measurement and the positioning estimate, or an error if the wireless device is unable to report the measurement and the positioning estimate.

Embodiment D3. The method of Embodiment D1, wherein the location information request one or more of:

is included in a Long Term Evolution (LTE) positioning protocol (LPP) message; and

indicates a type of measurement per positioning method.

Some embodiments may include one or more of the following:

Embodiment A1. A network node configured to communicate with a wireless device (WD), the network node configured to, and/or comprising a radio interface and/or comprising processing circuitry configured to:

obtain an indication of at least one WD capability, the at least one WD capability comprising a WD-based positioning capability and a minimization of drive test (MDT) capability; and

notify at least one other network node about the indicated at least one WD capability.

Embodiment A2. The network node of Embodiment A1, wherein the at least one other network node comprises a radio access network (RAN) node and an operations and maintenance (OAM) node.

Embodiment A3. The network node of any one of Embodiments A1 and A2, wherein the positioning report is configured to include WD positioning measurements if the WD indicates that the WD is capable of WD-based positioning and/or MDT reporting.

Embodiment A4. The network node of any one of Embodiments A1-A3, wherein the indication of the at least one WD capability is associated to the WD's International Mobile Subscriber Identity (IMSI).

Embodiment A5. The network node of any one of Embodiments A1-A4, wherein the positioning report includes at least one MDT log.

Embodiment B1. A method implemented in a network node, the method comprising:

obtaining an indication of at least one WD capability, the at least one WD capability comprising a WD-based positioning capability and a minimization of drive test (MDT) capability; and

notifying at least one other network node about the indicated at least one WD capability.

Embodiment B2. The method of Embodiment B1, wherein the at least one other network node comprises a radio access network (RAN) node and an operations and maintenance (OAM) node.

Embodiment B3. The method of any one of Embodiments B1 and B2, wherein the positioning report is configured to include WD positioning measurements if the WD indicates that the WD is capable of WD-based positioning and/or MDT reporting.

Embodiment B4. The method of any one of Embodiments B1-B3, wherein the indication of the at least one WD capability is associated to the WD's International Mobile Subscriber Identity (IMSI).

Embodiment B5. The method of any one of Embodiments B1-B4, wherein the positioning report includes at least one MDT log.

Embodiment C1. A wireless device (WD) configured to communicate with a network node, the WD configured to, and/or comprising a radio interface and/or processing circuitry configured to:

indicate at least one WD capability, the at least one WD capability comprising a WD-based positioning capability and a minimization of drive test (MDT) capability;

receive a configuration of a positioning report based at least in part on the at least one WD capability; and

send the configured positioning report including the WD's location information.

Embodiment C2. The WD of Embodiment C1, wherein the positioning report is configured to include WD positioning measurements if the WD indicates that the WD is capable of WD-based positioning and/or MDT reporting.

Embodiment C3. The WD of any one of Embodiments C1 and C2, wherein the positioning report includes at least one MDT log.

Embodiment D1. A method implemented in a wireless device (WD), the method comprising:

indicating at least one WD capability, the at least one WD capability comprising a WD-based positioning capability and a minimization of drive test (MDT) capability;

receiving a configuration of a positioning report based at least in part on the at least one WD capability; and

sending the configured positioning report including the WD's location information.

Embodiment D2. The method of Embodiment D1, wherein the positioning report is configured to include WD positioning measurements if the WD indicates that the WD is capable of WD-based positioning and/or MDT reporting.

Embodiment D3. The network node of any one of Embodiments D1 and D2, wherein the positioning report includes at least one MDT log.

Embodiment E1. A network node configured to communicate with a wireless device (WD), the network node configured to, and/or comprising a radio interface and/or comprising processing circuitry configured to:

obtain an indication of at least one WD capability, the at least one WD capability comprising a WD-based positioning capability and a minimization of drive test (MDT) capability; and

configure the WD with a positioning report based at least in part on the at least one WD capability.

Embodiment E2. The network node of Embodiment E1, wherein the network node and/or radio interface and/or processing circuitry is further configured to at least one of:

receive the WD's location information including the configured positioning report; and

determine a radio access network (RAN) node serving the WD.

Embodiment E3. The network node of any one of Embodiments E1 and E2, wherein the positioning report is configured to include WD positioning measurements if the WD indicates that the WD is capable of WD-based positioning and/or MDT reporting.

Embodiment E4. The network node of any one of Embodiments E1-E3, wherein the indication of the at least one WD capability is associated to the WD's International Mobile Subscriber Identity (IMSI).

Embodiment E5. The network node of any one of Embodiments E1-E4, wherein the positioning report includes at least one MDT log.

Embodiment F1. A method implemented in a network node, the method comprising:

obtaining an indication of at least one WD capability, the at least one WD capability comprising a WD-based positioning capability and a minimization of drive test (MDT) capability; and

configuring the WD with a positioning report based at least in part on the at least one WD capability.

Embodiment F2. The method of Embodiment F1, further comprising at least one of:

receiving the WD's location information including the configured positioning report; and/or

determining a radio access network (RAN) node serving the WD.

Embodiment F3. The method of any one of Embodiments F1 and F2, wherein the positioning report is configured to include WD positioning measurements if the WD indicates that the WD is capable of WD-based positioning and/or MDT reporting.

Embodiment F4. The method of any one of Embodiments F1-F3, wherein the indication of the at least one WD capability is associated to the WD's International Mobile Subscriber Identity (IMSI).

Embodiment F5. The method of any one of Embodiments F1-F4, wherein the positioning report includes at least one MDT log.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| AMF | Access Management Function |
| LCS | Location Client services |
| LMF | Location Management Function |
| RSRP | Reference Signal Received Power |
| RSTD | Reference Signal Time Difference |
| TOA | Time of Arrival |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

What is claimed is:

1. A method implemented in a network node (16), the method comprising:
identifying (S160) a wireless device, WD (22), operating in a WD-based positioning mode;
receiving (S162) at least one positioning measurement and a positioning estimate from the identified WD (22); and
optionally, using (S164) the received at least one positioning measurement to perform at least one positioning action.

2. The method of claim 1, further comprising sending a location information request to the WD (22), the location information request requesting the at least one positioning measurement from the WD (22) operating in the WD-based positioning mode.

3. The method of claim 2, wherein the network node (16) comprises a location management function, LMF.

4. The method of any one of claims 2 and 3, wherein the location information request includes a location information type, the location information type instructing the WD (22) operating in the WD-based positioning mode to report the requested at least one positioning measurement.

5. The method of claim 4, wherein the location information type instructs the WD (22) operating in the WD-based positioning mode to report both the at least one positioning measurement and the positioning estimate.

6. The method of any one of claims 2-5, wherein:
receiving the at least one positioning measurement and the positioning estimate from the WD (22) as a result of the location information request.

7. The method of claim 1, further comprising configuring the identified WD (22) to perform a minimization of drive test, MDT, logging.

8. The method of claim 7, wherein the network node (16) is an operations and maintenance, OAM, network node (16).

9. The method of any one of claims 7 and 8, wherein configuring the WD (22) to perform MDT logging further comprises configuring the WD (22) to include at least one positioning measurement from the MDT logging in a positioning report.

10. The method of claim 9, further comprising receiving the positioning report comprising the at least one positioning measurement from the WD (22) operating in the WD-based positioning mode.

11. A method implemented in a wireless device, WD (22), the method comprising:
operating (S166) in a WD-based positioning mode;
while operating the WD-based positioning mode, receiving (S168) a request to report at least one positioning measurement; and
reporting (S170) the requested at least one positioning measurement and a positioning estimate.

12. The method of claim 11, wherein receiving the request comprises receiving a location information request, the location information request requesting the at least one positioning measurement and the positioning estimate from the WD (22) operating in the WD-based positioning mode.

13. The method of claim 12, wherein receiving the request to report the at least one positioning measurement from a location management function, LMF, network node (16).

14. The method of any one of claims 12 and 13, wherein the location information request includes a location information type, the location information type instructing the WD (22) operating in the WD-based positioning mode to report the requested at least one positioning measurement.

15. The method of claim 4, wherein the location information type instructs the WD (22) operating in the WD-based positioning mode to report both the at least one positioning measurement and the positioning estimate.

16. The method of any one of claims 12-15, further comprising:
performing the at least one positioning measurement; and
calculating the positioning estimate for the WD (22) based at least in part on the at least one positioning measurement.

17. The method of claim 11, further comprising receiving a configuration to perform a minimization of drive test, MDT, logging.

18. The method of claim 17, wherein receiving the configuration to perform the MDT logging from an operations and maintenance, OAM, network node (16).

19. The method of any one of claims 17 and 18, wherein the configuration instructs the WD (22) to include at least one positioning measurement from the MDT logging in a positioning report.

20. The method of claim 19, wherein reporting further comprises sending the positioning report comprising the at least one positioning measurement from the MDT logging.

21. A network node (16) comprising processing circuitry (68), the processing circuitry (68) configured to cause the network node (16) to:
identify a wireless device, WD (22), operating in a WD-based positioning mode; and
receive at least one positioning measurement and a positioning estimate from the identified WD (22); and
optionally, using the received at least one positioning measurement to perform at least one positioning action.

22. The network node (16) of claim 21, wherein the processing circuitry (68) is further configured to cause the network node (16) to send a location information request to the WD (22), the location information request requesting the at least one positioning measurement from the WD (22) operating in the WD-based positioning mode.

23. The network node (16) of claim 22, wherein the network node (16) comprises a location management function, LMF.

24. The network node (16) of any one of claims 22 and 23, wherein the location information request includes a location information type, the location information type instructing the WD (22) operating in the WD-based positioning mode to report the requested at least one positioning measurement.

25. The network node (16) of claim 24, wherein the location information type instructs the WD (22) operating in the WD-based positioning mode to report both the at least one positioning measurement and the positioning estimate.

26. The network node (16) of any one of claims 22-25, wherein the processing circuitry (68) is further configured to cause the network node (16) to:
receive the at least one positioning measurement and the positioning estimate from the WD (22) as a result of the location information request.

27. The network node (16) of claim 21, wherein the processing circuitry (68) is further configured to cause the network node (16) to configure the identified WD (22) to perform a minimization of drive test, MDT, logging.

28. The network node (16) of claim 27, wherein the network node (16) is an operations and maintenance, OAM, network node (16).

29. The network node (16) of any one of claims 27 and 28, wherein the processing circuitry (68) is configured to cause the network node (16) to configure the WD (22) to perform MDT logging by being configured to cause the network node (16) to configure the WD (22) to include at least one positioning measurement from the MDT logging in a positioning report.

30. The network node (16) of claim 29, wherein the processing circuitry (68) is further configured to cause the network node (16) to receive the positioning report comprising the at least one positioning measurement from the WD (22) operating in the WD-based positioning mode.

31. A wireless device, WD (22), comprising processing circuitry (84), the processing circuitry (84) configured to cause the WD (22) to:
operate in a WD-based positioning mode;
while operating the WD-based positioning mode, receive a request to report at least one positioning measurement; and
report the requested at least one positioning measurement and a positioning estimate.

32. The WD (22) of claim 31, wherein the processing circuitry (84) is configured to cause the WD (22) to receive the request by being configured to cause the WD (22) to receive a location information request to the WD (22), the location information request requesting the at least one positioning measurement and the positioning estimate from the WD (22) operating in the WD-based positioning mode.

33. The WD (22) of claim 32, wherein the processing circuitry (84) is configured to cause a network node (16) to receive the request to report the at least one positioning measurement from a location management function, LMF, network node (16).

34. The WD (22) of any one of claims 32 and 33, wherein the location information request includes a location information type, the location information type instructing the WD (22) operating in the WD-based positioning mode to report the requested at least one positioning measurement.

35. The WD (22) of claim 34, wherein the location information type instructs the WD (22) operating in the WD-based positioning mode to report both the at least one positioning measurement and the positioning estimate.

36. The WD (22) of any one of claims 32-35, wherein the processing circuitry (84) is further configured to cause the WD (22) to:
perform the at least one positioning measurement; and
calculate the positioning estimate for the WD (22) based at least in part on the at least one positioning measurement.

37. The WD (22) of claim 31, wherein the processing circuitry (84) is further configured to cause the WD (22) to receive a configuration to perform a minimization of drive test, MDT, logging.

38. The WD (22) of claim 37, wherein the processing circuitry (84) is configured to cause the WD (22) to receive the configuration to perform the MDT logging from an operations and maintenance, OAM, network node (16).

39. The WD (22) of any one of claims 37 and 38, wherein the configuration instructs the WD (22) to include at least one positioning measurement from the MDT logging in a positioning report.

40. The WD (22) of claim 39, wherein the processing circuitry (84) is configured to cause the WD (22) to report by being configured to cause the WD (22) to send the positioning report comprising the at least one positioning measurement from the MDT logging.

41. An apparatus comprising processing circuitry (68) configured to execute computer instructions to perform any one or more of the methods of claims 1-10.

42. An apparatus comprising processing circuitry (84) configured to execute computer instructions to perform any one or more of the methods of claims 11-20.
